(19) United States
(12) Patent Application Publication
(10) Pub. No.: US 2011/0072862 A1
(43) Pub. Date: Mar. 31, 2011

(54) SECURITY DEVICE FOR SECURING PORTABLE OBJECTS

(76) Inventors: Meir Avganim, Gealya (IL); Max Moskowitz, Kew Gardens Hills, NY (US)

(21) Appl. No.: 12/890,857

(22) Filed: Sep. 27, 2010

Related U.S. Application Data
(60) Provisional application No. 61/245,825, filed on Sep. 25, 2009.
(60) Provisional application No. 61/286,190, filed on Dec. 14, 2009.

(51) Int. Cl. E05B 73/00

(52) U.S. Cl. 70/58

(57) ABSTRACT

An apparatus for securing equipment against theft, includes a small lock with a T-bar protruding from one end, the lock being operable by a key, a combination and the like, an anchor assembly, and a cable extending between and connecting the lock to the anchor assembly. An opening passes through the anchor assembly, large enough to thread the lock through that opening. This enables the anchor assembly to be anchored to an immovable object and then secure the lock end via its T-bar in the standardized, typically a rectangular security slots provided in equipment such as in laptop or notebook computers and similar electronic devices.

### CROSS REFERENCE TO RELATED APPLICATIONS

This application claims the benefit of U.S. Provisional Application No. 61/245,825 filed on Sep. 25, 2009, and provisional application No. 61/286,190 filed on Dec. 14, 2009. The contents of both said applications are incorporated by reference herein.

### BACKGROUND OF THE INVENTION

1. Field of Invention

The present invention relates to locks. More particularly, the present invention relates to locks suitable for securing small, portable components, such as desktop or laptop computers, PDAs, music/video players and the like.

2. Description of Related Art

Due to the small size of many modern electrical components, such as computers and other electronic devices, a great concern exists for the physical security of such components. For example, in the office or commercial environment, the threat of theft of such electronic devices is high, due to both the relatively high cost of the components, and the ease with which they can be pilfered. A need has therefore been present in the art for means to secure the electronic or other components, to prevent theft and/or loss of the components.

A problem with securing such items, however, is the general lack of a conventional means to secure the components. For example, one approach in the past has been to use a bicycle-type locking device, where a locking cable is passed through a suitable holding means on the electronic component as well as to a suitable solid support, such as a desk. This has the result of effectively “tying down” the device to the solid support. However, this approach has become less suitable, as the size of the electronic components continue to decrease and the demand for more convenient locking systems has increased.

Many models of portable computers today are equipped with safety means. The safety means usually includes a standardized slot on an outer wall or housing of the computer. A variety of locking devices, generally with steel cables attached to the locking devices, have been developed for the attachment and disengagement thereof to such slots.

Because the cable is usually long (in the order of 4 to 6 feet) it is desirable to have an arrangement for convenient storage of the locking device, particularly the long cable. Further, to reduce clutter, particularly desk-top clutter, it is desirable to be able to adjust the cable length.

U.S. Pat. No. 7,013,685 discloses a locking device with an assembly to retract and house the cable. A drawback of the device shown by U.S. Pat. No. 7,013,685 is that, because the assembly occupies a significant amount of space, in order to realize a reasonably sized and commercially viable device, thinner cable must be used (e.g. cable having less than 4 mm diameter). As a result, such a device is less secure in that the cable can be cut relatively easily with hand tools such as ordinary pliers. Conventional, sturdier cables measure five or more millimeters in diameter and these cannot practically be reeled in by the mechanism of the U.S. Pat. No. 7,013,685.

### BRIEF DESCRIPTION OF THE DRAWINGS

FIG. 1 illustrates a prior art cable and lock security facility for electronic equipment incorporating a security slot.

FIG. 1B shows the lock assembly of FIG. 1 in use.

FIG. 1C shows the lock assembly tethered to the wall of electronic equipment.

FIG. 2A shows a first embodiment of the present invention with a rigid plate incorporating a threading opening for the lock in accordance with the first embodiment.

FIG. 2B shows a first alternative to the second embodiment.

FIG. 2C shows the embodiment of FIG. 2B in use.

FIG. 2D illustrates a second use of the embodiment of FIG. 2C.

FIG. 2E shows the embodiment of FIG. 2B with an added feature that facilitates stowing of the lock cable.

FIG. 2F shows a blank steel plate for creating another alternative for the embodiment of FIG. 2A.

FIG. 2G illustrates the formed version of FIG. 2F.

FIG. 2H shows FIG. 2G's inside view.

FIGS. 3 and 4 illustrate another embodiment of the invention in FIG. 2A.

FIGS. 5A, 5B, 5C and 5D illustrate the embodiments of the invention.

FIGS. 6A and 6B show modifications to FIGS. 5A-5D.

FIGS. 7A, 7B, 7C and 7D illustrate further embodiments of the invention.

FIGS. 8A, 8B, 8C and 8D illustrate another embodiment of the invention.

FIGS. 9A and 9B show a further embodiment of the invention.

FIG. 10 is another version of the embodiment of FIG. 2B, utilizing a flat, H-shaped component for threading the lock assembly cable therethrough and thereon.

FIG. 11A discloses a perspective view of a hub/retainer arrangement according to another embodiment of the present invention.

FIG. 11B shows a side plan view of the arrangement of FIG. 11A in which broken lines disclose features hidden from view.

FIG. 11C shows another side plan view of the hub/retainer arrangement of FIG. 11A.

FIG. 11D shows a plan view in the direction of arrows 11D-11D.

FIG. 11E shows a plan view in the direction of arrows 11E-11E.

FIG. 11F shows a plan view in the direction of arrows 11F-11F.

FIG. 11G shows another side plan view of the hub/retainer arrangement of FIG. 11A.

FIG. 11H shows a side plan view in the direction of arrows 11H.

FIG. 11I shows a plan view in the direction of arrows 11I.

FIG. 11J shows a cross-sectional view along line 11J-11J viewed in the direction of the arrows.

FIG. 11K shows a cross-sectional view along line 11K-11K viewed in the direction of the arrows.

FIG. 11L shows a perspective view of a portion of a lock/cable assembly using the hub/retainer (rendered transparent) arrangement of FIG. 11A.

FIG. 11M shows a side plan view of the arrangement of FIG. 11L.

FIG. 11N shows another side plan view of the arrangement of FIG. 11L.

FIG. 11O shows yet another plan view of the arrangement of FIG. 11L.

FIG. 11P shows a further plan view of the arrangement of FIG. 11L.

FIG. 12A shows a perspective view of another hub/retainer arrangement for use with a cable and lock assembly.

FIG. 12B shows a side plan view of the hub/retainer of FIG. 11A.

FIG. 12C shows another side plan view of the hub/retainer of FIG. 12A.

FIG. 12D shows a plan view in the direction of arrows 12D.

FIG. 12E shows a plan view in the direction of arrows 12E.

FIG. 12F shows a plan view in the direction of the arrows 12F.

FIG. 12G is a side plan view in the direction of the arrows 12G.

FIG. 12H is a perspective of the hub/retainer arrangement viewed from a different direction.

FIG. 12I shows a cross-sectional view along line 12I-12I viewed in the direction of the arrows.

FIG. 12J shows another perspective view of the hub/retainer arrangement of FIG. 12A viewed from a different angle.

FIG. 12K shows another side plan view of the arrangement shown in FIG. 12A.

FIG. 12L shows a cross-sectional view along line 12L-12L viewed in the direction of the arrows.

FIG. 13 shows an accessory and a cable/lock combination according to one aspect of the present invention.

FIG. 14 shows a top plan view of a locking tab and cable/lock combination according to another aspect of the present invention.

FIG. 14B shows a view in the direction of arrows 14B-14B.

FIG. 14C shows a top plan view of another variation of a locking tab with a lock/cable assembly.

FIG. 14D shows a side plan view in the direction of arrows 14D.

FIG. 15A shows a plan view of an adapter plate according to another aspect of the present invention.

FIG. 15B shows a side plan view of the adapter plate of FIG. 15A.

FIG. 15C illustrates a method of assembling the adapter plate of FIG. 15A to an object.

FIG. 15D shows a lock assembly suitable for use with an adapter plate according to FIG. 15A.

FIG. 16A shows a box according to the present invention in an open state.

FIG. 16B shows the box of FIG. 16B in a closed state.

FIG. 16C shows the box of FIG. 16B secured using a lock and cable assembly.

FIG. 16D illustrates a suitable lock assembly for use with the box of FIG. 16A.

FIG. 17A shows a lock and cable assembly according to another aspect of the present invention.

FIG. 17B shows a side plan view of the arrangement of FIG. 17B.

FIG. 17C illustrates the use of the lock and cable assembly of FIG. 17A.

FIG. 18A shows a perspective view of an adapter according to the present invention in a disassembled state.

FIG. 18B shows a side plan view of a disassembled adapter as shown by FIG. 18A.

FIG. 18C shows a plan view in the direction of arrows 18C, FIG. 18B.

FIG. 18D shows a perspective view of an adapter according to the present invention.

FIG. 18E shows a side plan view of an adapter according to the present invention.

FIG. 18F shows a plan view of a portion of an adapter according to the present invention.

FIG. 18G shows a plan view in the direction of arrows 18G, FIG. 18E.

FIG. 18H illustrates an adapter as received in a conventional lock slot.

FIG. 18I shows a lock assembly suitable for use with one example of an adapter according to the present invention.

FIG. 18J shows a perspective view of a sleeve suitable for use with an adapter according to the present invention.

FIG. 19A illustrates a clamp according to the present invention.

FIG. 19B illustrates another example of a clamp according to the present invention.

FIGS. 20, 20A, 20B, 20C and 20D show an alternate adapter embodiment.

FIG. 21 and FIG. 21A are drawings showing a lock suitable to be used with the adapter of FIG. 20.

FIG. 22 shows a lock similar to that of FIG. 21, but with a triangular locking member.

FIG. 23 shows the lock of FIG. 21 inserted into the adapter of FIG. 20.

### DESCRIPTION

Although the present invention is hereinafter described in relation to particular embodiments thereof, many other variations and modifications and other uses will become apparent to those skilled in the art. It is preferred, therefore, that the present invention be limited not by the specific disclosure herein, but only by the appended claims. Thus, while the present invention is illustrated with respect to the following specifically described locks and locking mechanisms, the present invention is in no way limited to the structures described below.

In general terms, the present invention relates to a lock, or a locking system or locking method, which helps to prevent theft of small components, such as portable or even desktop computers, peripherals, telephones, purses, suitcases, or the like.

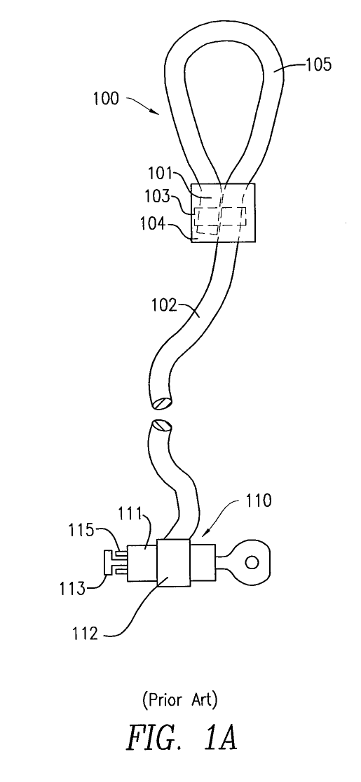

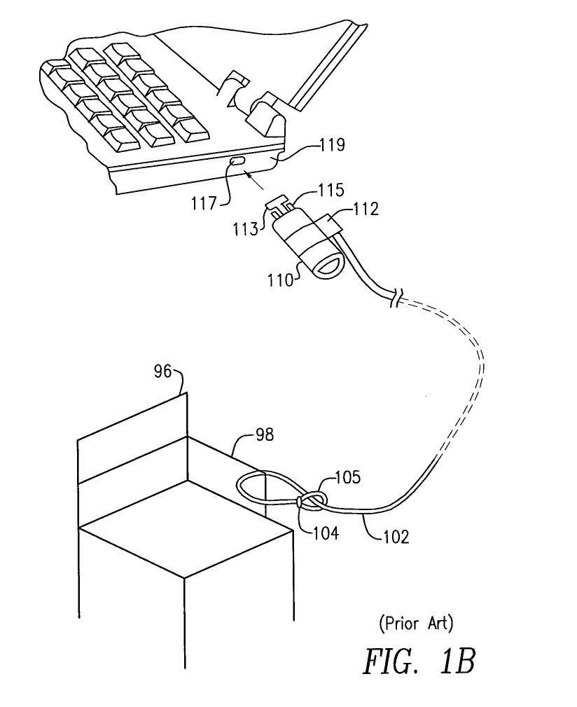

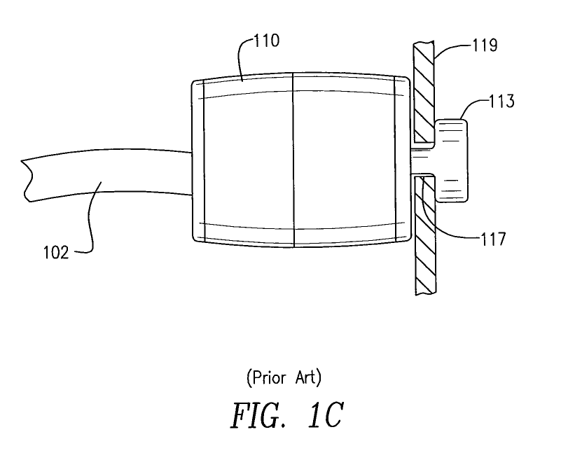

FIG. 1A illustrates an example of a locking device 100 according to the prior art. As shown in FIG. 1A, device 100 includes a cable 102 connected at one end via a sleeve 112 to a lock assembly 110. The other end 101 of cable 102 is folded into itself to form a loop 105, which is secured by a crimping ring 103 and covered with a plastic cap 104.

Lock assembly 110 has a lock body 111 suitable for locking cable 102 to a portable object such as a portable laptop computer. Examples of such lock assemblies are shown by U.S. Pat. Nos. 6,705,133, 7,013,685, and 7,111,479, the entire disclosure of which is incorporated by reference herein as background. As is well known, to secure a laptop or the like portable object, lock assembly 110 is passed inside loop 105 to form a noose around a portion of a body whereby cable 102 becomes tethered to the body. Thereafter, lock assembly 110 is locked to the portable object, whereby the portable object is secured to the closed body. For example, a noose may be formed around the arm rest 98 of a chair 96 as illustrated by FIG. 1B. Note that the lock assembly 110 includes a T-shaped latch or bar 113 and slot holding pins 115. T-shaped latch 113 is rotatable and is configured to be received in a rectangularly-shaped through slot 117 in the body (casing) 119 of a portable object, for example, a laptop, a monitor or the like. A standardized dimension for such a slot is 3 mm×7 mm, but the slot can be formed at other sizes, including 3.5 mm×8 mm or any other desirable size. To secure lock assembly 110 (and thus cable 102) to the portable object, T-shaped latch 113 is longitudinally aligned with rectangular slot 117 and inserted therein from one side of body 119 until it reaches the other, opposite side thereof. Thereafter, T-shaped latch 113 is rotated until the head of T-shaped latch 113 is longitudinally transverse to the longitudinal axis of slot 117, whereby body 119 catches T-shaped latch 113 and prevents its removal thus locking lock assembly 110 in place as is known in the art (see FIG. 1C).

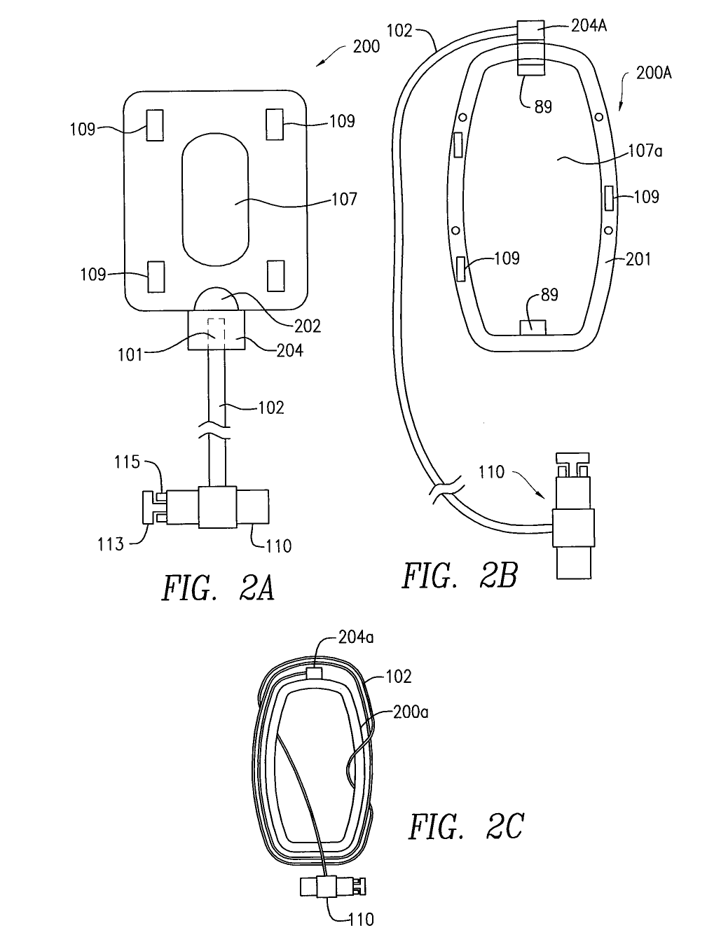

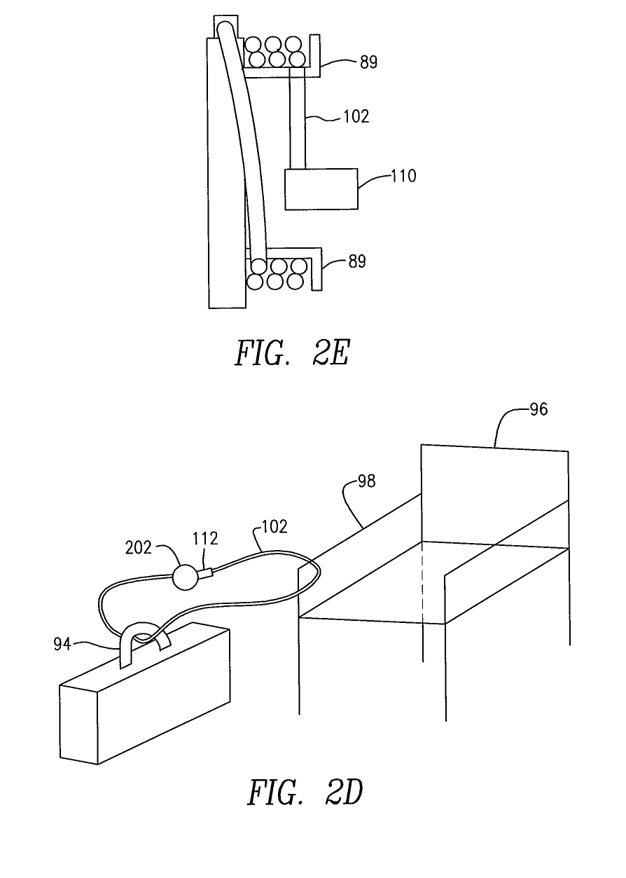

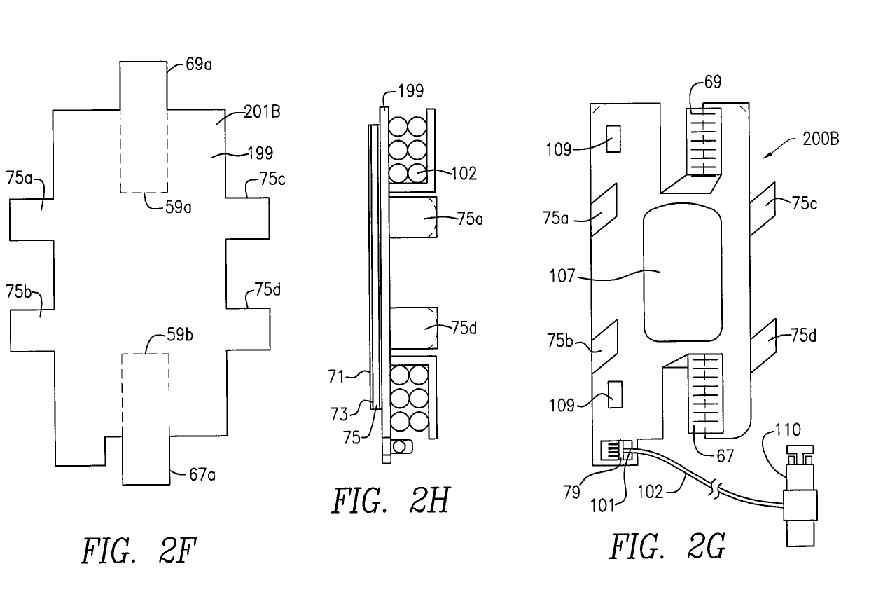

Referring to FIG. 2A, according to one aspect of the present invention, loop 105 is replaced with a plate assembly 200. Plate assembly 200 includes a joint 202 having an anchor 204 that is attached to a hub 202 by welding or the like suitable method. Anchor 204 is mechanically coupled to an end 111 of cable 102. In part, plate assembly 200 serves at least the same function as loop 105 in the prior art. That is, plate 200 includes a large opening 107 to receive lock assembly 110 therein, whereby a noose can be realized in order to secure cable 102 to another object, e.g. a chair, a table, a desk or the like. Note that in order to perform its intended function, plate 200 is made from a material that cannot be easily cut, for example, from steel or the like material.

In the embodiment shown by FIG. 2A, plate 200 may be a steel plate one or several millimeters in thickness (preferably plastic covered) and anchor 204 may be a steel body which is welded to the exterior surface of plate 200. Note that plate assembly 200 may also be made from thick plastic through injection molding or the like method.

According to one aspect of the present invention, plate assembly 200 may be provided with one (or more) slot 109 that extends therethrough. Slot 109 may be rectangular and sized to receive T-shaped latch 113 whereby lock assembly 110 can be locked to plate 200 in the same manner as being locked to the body 119 of a portable object as described above. Thus, an arrangement according to the present invention can be used to tether and secure a portable object that includes a slot 117 as described, or, alternatively, it can form a closed loop so that it may be used to secure other types of portable objects such as brief cases, luggage, clothing and the like to chairs, tables, etc. Specifically, for example, a loop may be formed by locking lock assembly 110 to plate 200 in order to secure the armrest 98 of a chair 96 to the handle 94 of a brief case as shown by FIG. 2D.

In an alternative embodiment of FIG. 2B, plate arrangement 200 is replaced by an elongate, stretched ring 200A made from flat steel or a plastic sheet and having an opening 107A for passing the lock assembly 110 therethrough as described earlier. The ring body 201 may further include one slot 109 or several security slots 109 to serve the same function as described above. An anchor 204a may be welded to one edge of ring 200A, for example a blind metal sleeve, to receive therein an end of cable 102.

The embodiment of FIG. 2B is advantageous in several respects, owing to the following features thereof. Its central opening 107a may have width of 2½ to 6 cm in a length with the general dimensions of 5 to 10 cm. The thickness of the ring is preferably 1.5 to 5 mm and the width of the wall preferably measures less than 1 cm in order to easily accommodate the security slots 109 measuring 3.5×8 mm to be formed therein. Also, the joint 204a of the cable to ring may be a swivel joint. Since the outer diameter of a typical security table 102 is on the order of about half a centimeter, in prior art of computer security devices it is typically difficult to store away the cable, as it tended to be difficult and unwieldy to neatly roll it up in one's hand into a nice package.

However, with the embodiment of FIG. 2B, it is contemplated that one can simply place his or her fingers through the opening 107A, grasp the cable and roll it up in a dimension approximating the shape of the ring 200a. The cable 102 can be woven inside and outside of the ring as shown in FIG. 2C to any desired length, which not only allows adjustment of the cable length, but also allows its neat stowage.

To further facilitate the rolling up of the stiff cable 102, FIGS. 2B and 2E show L-shaped winding lugs 89 which protrude from the plane of the ring and which allow the cable to be rolled up thereon, as illustrated in FIG. 2E. Preferably, these winding lugs would be made of smoothed, and preferably plastic covered, steel and to similarly allow the length of the cable to be easily adjusted. Of course, the added benefit is that the length of the cable which is now rendered quite adjustable can be continued to be used so that the lock assembly 110 can be connected either to computers or back to the ring 200a itself to secure luggage, or even clothing (by snaking the lock end of the cable through a sleeve of a fur coat, etc., which may be left on a bench at an airport waiting area.

Note that in FIG. 2E, the L-shaped lugs have been positioned so that they accommodate six turns of the cable, in two rows of three cable turns each. However, these winding lugs can be formed so that they project down into the opening 107a and have greater depths, so that only two or only a single turn of cable is accommodated and the cable is taken up by having three or four or even seven cable layers, one on top of the other. Although only two such lugs 89 are shown, additional such lugs may be provided on the other sides of the ring. In addition, a clip may be provided on the ring itself or any of these winding lugs, in which the very end of the cable, where it is connected to the lock assembly 110, may be snapped into, to provide a neater and flatter assembly package. It should be noted that the winding lugs 89 may also be provided on the plate 200 of the embodiment shown in FIG. 2A by being mounted to the periphery of the plate 200. Further note that the lateral width of the ring in FIG. 2B, including its length-wise extending wall, may be made especially narrow, for example, less than 4-5 cm, so that it will allow itself to be slipped through a very narrow opening in a piece of furniture; for example, the handle of a desk drawer.

Referring to FIGS. 2F, 2G and 2H, another embodiment utilizes a flat stock of metal which can be steel, aluminum or a metallic alloy which is generally rectangular, with jutting tabs 75a, 75b, 75c and 75d along the long sides thereof. The metallic web 199 also has jutting tabs 69a and 67a and the figure also illustrates score lines 59a and 59b. The basic metallic stamping 199 is intended to form the end plate 200B which is shown in FIG. 2G. This is done by bending up on the tabs 75a-75d to get cable retainer tabs that jut out perpendicularly to the plane of the web 200B, as shown in FIG. 2G. Further, the tabs 69a and 67a are cut along the longitudinal score lines 59a, 59b and bend 90° up and then re-enterantly at 90° to form the retaining lugs 69 and 67 shown in FIG. 2G. Still further, at the center, the cable threading opening 107 for the lock assembly 110 is formed.

This unitary piece, made from a single stock of metallic stamping includes a jutting portion at the lower left-hand corner to which the end 101 of the cable 102 is attached by a crimped clamp 79. The cable terminates in the lock assembly 110. In use, the lock can be threaded through an opening in the handle of a door or to an chair arm handle and then threaded through the opening 107 and then attached to the security slot 117 in electronic equipment.

However, during initial assembly 1 and thereafter for stowage and normal use, the cable 102 is wound on the winding lugs 67, 69, as illustrated in the side view of FIG. 2H. Thus, rather than having the typical cluttered look and feel, the cable 107 of the present invention is delivered to customers in a neat, uncluttered package and only so much of the cable is unwound as is needed for a particular use.

Normally, the wrapped cable may tend to bulge out of the sides, but the tabs 7a-75b retain it within the confines of the basic web 200B. It should also be noted that the embodiment of FIG. 2G can be formed from a plastic material in an injection molding machine. Note also, the standardized security slots 109 formed on the web 200B, which allow the lock to be threaded through the handle of a piece of luggage or to clothing and then locked to the web 200B. Even when the lock assembly 110 is connected to a security slot in a laptop, other lock assemblies 110 can be connected to the web 200B for purposes later described. As noted, it is preferred that the security slot be formed as a rectangular slot with a width of at least 3.5 mm plus 5% and a length of 8 mm plus 5%. The edges of the basic web can be rounded, as can be the corners of the tabs 75a-75d or the edges of the winding lugs 67 and 69.

In FIG. 2H, elements 71, 73 and 75 represent a Velcro® strip with 71 being a release sheet covering an adhesive layer. Thus, the device can be glued to one surface of a laptop computer and selectively attached/detached to or therefrom.

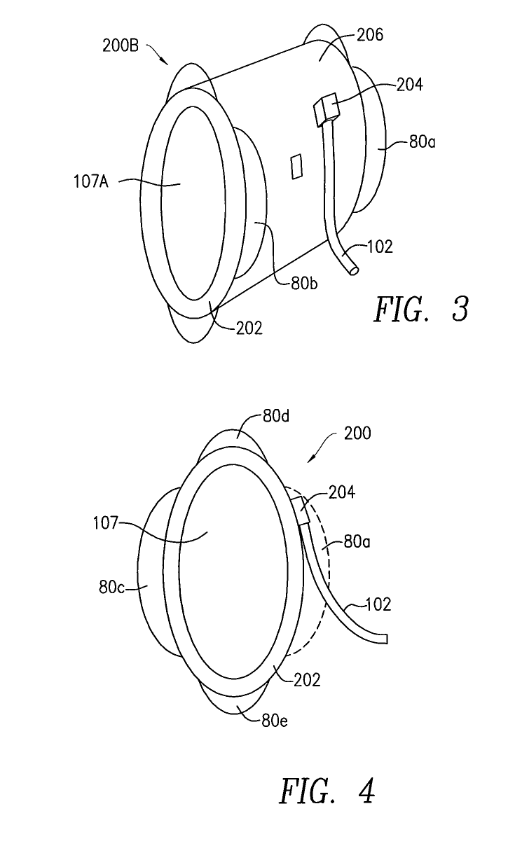

Referring to FIG. 3, instead of a tab 200A, a hub 200B is provided which may be a cylindrical steel body having a generally circular or oval cross section and a cylindrical/oval outer surface 206. In this embodiment, anchor 204 may be welded to the outer surface 206. Exterior surface 206 extends several centimeters in the axial direction to allow several turns of the cable 102 to be wound thereon for storage. Note that anchor 204 may be oriented so that the central axis of cable 102, when cable 102 is stretched into a straight line, will be oriented in a direction transverse to the direction of the central axis of hub 202 to allow for better winding of cable 102 around hub 202. Several stops 80a, 80b, 80c, etc. (see also FIG. 4) are provided to prevent the cable from slipping off the hub.

In FIGS. 3 and 4, the oval cross-section transverse to the central axis advantageously reduces the thickness of hub 202 in one direction. Thus, when cable 102 is wound around hub 202, the arrangement will have a reduced profile allowing for easier storage in carrying cases such as brief cases.

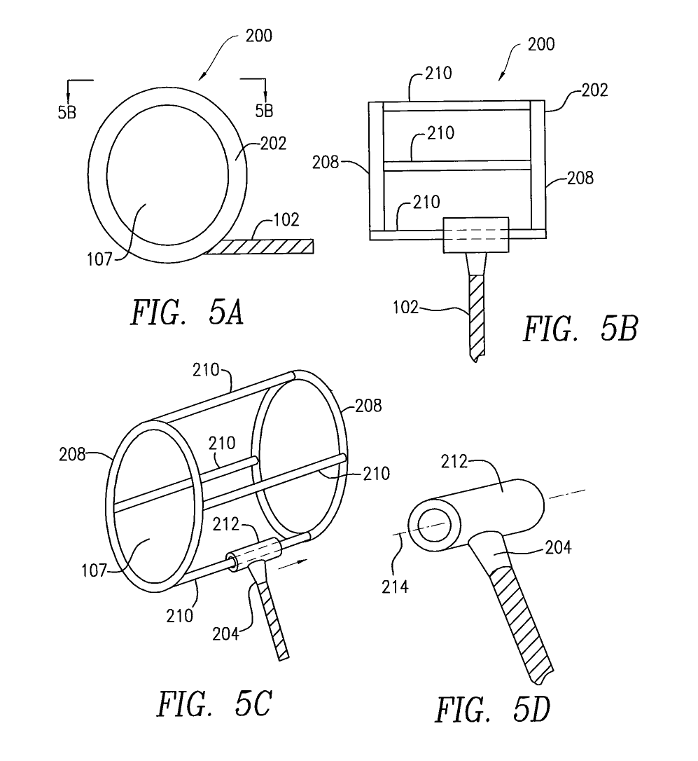

Referring to FIGS. 5A-5D, according to another embodiment of the present invention, hub assembly 200 may include a hub 202 that is made from a plurality of wires arranged and coupled to one another to form a bobbin-like structure. Specifically, a hub 202 in this embodiment includes two rings 208 (e.g. steel rings) that are spaced from and coupled to one another using a plurality of metallic rods (e.g. steel rods) 210. Each rod 210 is coupled (e.g. by welding) at one end thereof to one ring 208 and coupled (e.g. by welding) at another opposite end thereof to another ring 208, whereby rings 208 are spaced from and coupled to one another to realize a hub 202 for use in a hub assembly 200 according to the present invention. In the embodiment shown by FIGS. 5A-5D, anchor 204 may not be immovably coupled (e.g. by welding or the like method) to one rod 208, or, according to another aspect of the present invention, anchor 204 may be slidably coupled to a respective rod. Specifically, anchor 204 may be coupled to a sleeve 212. Sleeve 212 be a cylindrical body configured to receive a rod 208 in the interior 214 thereof. Consequently, sleeve 212 can slide along the direction of the central axis thereof parallel to the central axis of rod 208 to which it is slidably coupled.

In the embodiments described above, the interior space 107 of hub 202 is selected to be large enough to allow at least the passage of lock assembly 110. According to another aspect of the present invention, the interior space of hub 202 may be selected to allow passage of at least one finger and preferably two or more fingers of a human hand. Thus, a hub 202 can be supported by a person's hand while cable 102 is being wound. In the preferred embodiment, two or more fingers may be inserted in the interior space 107 of hub 202 and pressed against the interior walls of hub 202 in order to prevent the rotation thereof during the winding of cable 102. Note that, in the embodiment illustrated by FIGS. 4A and 4B, the long axis of the oval interior may be selected to allow for the passage of two fingers (i.e. it may be as wide as the total diameters of two to four fingers) while the short axis may be selected to be about the diameter of the lock assembly 110. Consequently, when two fingers are received in the interior of the oval-shaped hub 202, the rotation of hub 202 may be prevented when the interior wall of hub 202 abuts the fingers that are received in the interior thereof. For example, the long axis of the oval interior may be 1.5-2.0 inches, while its short axis may be 0.75-1.00 inch.

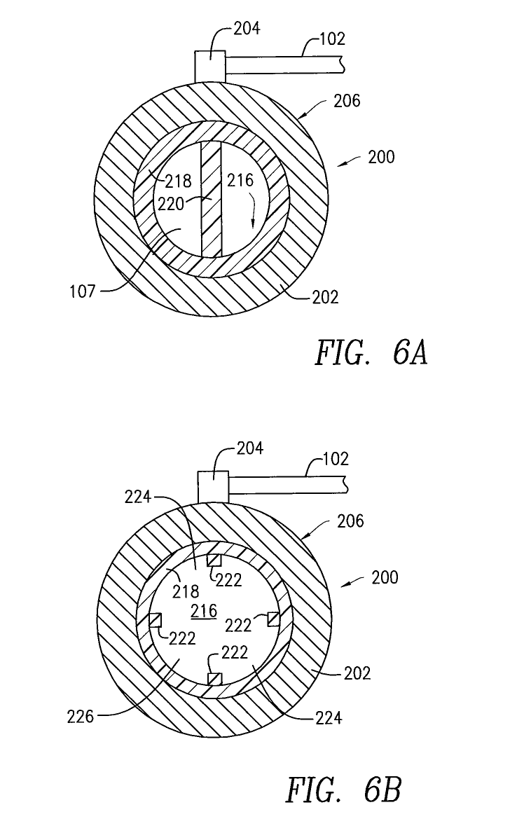

Referring to FIG. 6A, according to another aspect of the present invention, a hub 202 according to the present invention is provided with an insert 216. Insert 216 may be made from plastic and may include a cylindrical body 218 that is coupled to the interior of hub 202 by glue or the like. Insert 216 may further include a divider wall 220 disposed in and coupled to the interior surface thereof to divide its interior space into two adjacent spaces each space being wide enough to receive a human finger. Thus, once a human finger is received in each space, divider wall 220 would abut the fingers and prevent hub 202 from axial rotation during the winding of cable 102 over the outer surface 206 thereof.

Referring to FIG. 6B, in an alternative embodiment, cylindrical body 218 may include a plurality of circumferentially spaced teeth 222 disposed on the interior surface thereof. In this embodiment, the interior of insert 216 may be selected to receive one finger or two or more fingers of a human hand. In this embodiment, the spacing and the size of teeth 222 are selected so that a human finger (or fingers) fits inside cylindrical body 218 and is received in two directly opposite spaces between teeth 222 (e.g. spaces 224, or spaces 226). Consequently, the rotation of hub 202 may be prevented during the winding of cable 102 as teeth 222 abut the finger (or fingers) received in the interior of insert 216.

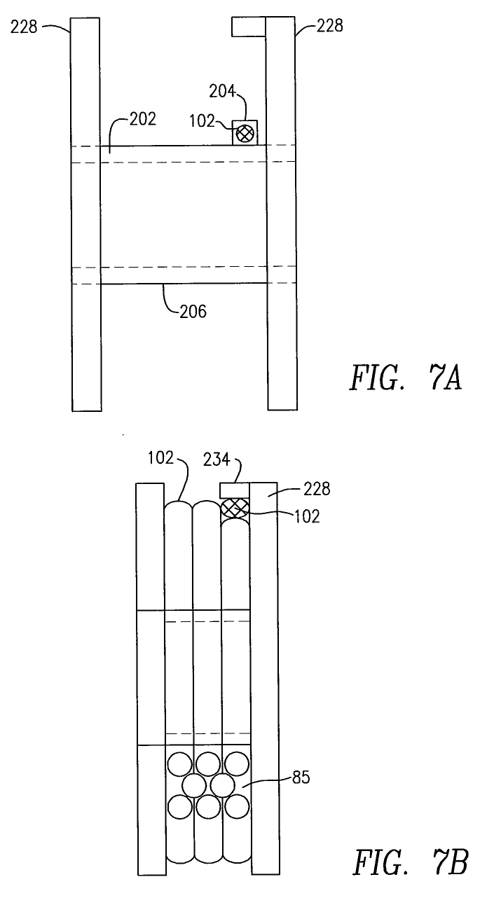

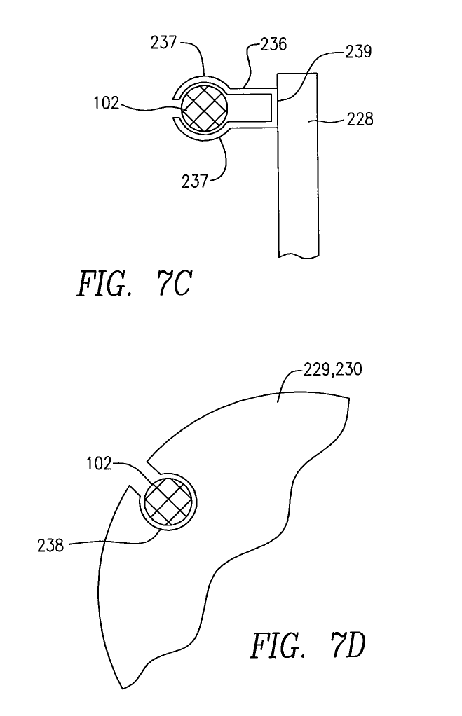

Referring now to FIG. 7A, according to another aspect of the present invention, any one of the hubs according to the present invention may be provided with retainers 228. The primary purpose of retainers 228 is to retain cable 102 on hub 202 by preventing the lateral movement of the same beyond the ends of hub 202. Thus, as illustrated by FIG. 7A, each retainer 228 can be located at a respective end of a hub 202. FIG. 7B (partly peeled away at a section 85) illustrates how cable 102 is retained between retainers 228 after it has been wound around a hub 202, with four layers and two to three cable widths in each layer.

A retainer 228 can be a flat circular or oval disk 230 as illustrated by FIG. 8A, or an arm 232 extending radially away from hub 202 as illustrated by FIG. 8B. Note that, when arms 232 are used, more than one pair of spaced arms 232 may be arranged circumferentially around the outer surface of hub 202 as illustrated by FIG. 8C. Note further that, as illustrated by FIG. 8D, when a disk 230 is used as a retainer, the disk may be provided with openings 234 to resemble a wheel with spokes. Alternatively, wire or the like may be used to fabricate retainers. Such retainers may be particularly suitable for use with the embodiment shown by FIGS. 5A-5D.

Retainers 228 (disks 230 and also arms 232) may be made from metals such as steel and welded directly to the exterior surface 206 of a hub 202, or, alternatively, retainers 228 may be made from plastic and either glued directly to exterior surface 206 of a hub 202, or coupled to the exterior surface of a plastic sleeve which receives a hub 202 in the interior thereof and is secured to said hub 202 by glue or the like adhesive.

FIG. 7B shows cable 102 (rendered transparent for illustrative purposes) wound around a hub 202. According to another aspect of the present invention, one of the retainers 228 (see right retainer) is provided with a protrusion 234 that extends toward to other retainer 228. Protrusion 234 is preferably wider than the diameter of cable 102. In order to prevent the wound cable from unraveling, cable 102 is tucked under protrusion 234 over a portion of one of the cable's windings. Naturally, because the length of the cable is known, protrusion 234 is located so that, upon proper winding, that portion of the cable 102 that is spaced close to (e.g. 1 cm or so) cable plug 110 is received under protrusion 234.

Referring to FIG. 7C, instead of protrusion 234, a cable clip 236 may be secured to a retainer and used to retain the end of cable 102 when it has been wound around hub 202. Note that cable clip 236 includes two flexible leaf spring arms 237 each having one end integral with a spine portion 239 and another end free to move. Further note that preferably each arm includes a cradle portion shaped to receive cable 102. Thus, arms 237 can be spread apart to receive cable 102 inside the cradle portions thereof, whereby the unraveling of cable 102 can be prevented.

Referring to FIG. 7D, in another alternative embodiment, when, for example, a disk is used as a retainer, a notch 238 may be provided on one of the disk retainers 228 to receive the end of cable 102 as illustrated. Note that the open side of notch 238 is less wide than the diameter of cable 102. Thus, when cable 102 is received in notch 238, it cannot readily escape. Alternatively, a strap can be used to prevent the unraveling of the wound cable 102. The strap, for example, can be extended between retainers 228 and over the wound cable 102. One end of the strap may be secured to one retainer 228, and the other end may be removably securable to the other retainer using snaps or the like in order to bridge over the wound cable and prevent the same from unwinding.

With further reference to FIG. 8A, one of the retainers 228 in FIG. 8A may have a so-called Velcro® (hook and loop) circular strip applied to one side thereof with the facing separable side being covered with an outer adhesive material with a release sheet applied thereto. This Velcro® covering is indicated by reference numeral 83. When a user purchases the product of the present invention, she or he may remove the release sheet and apply the adhesive to the top surface of his laptop. Thereafter, the hub 202 could be attached or detached from the computer through this hook and loop arrangement, allowing the one cable to always be attached to the computer, except when needed to secure the laptop computer. See also FIG. 2H.

Note generally, that similar hubs and retainers may be affixed to the top of the computer by means of Velcro® to enable the cables of the mouse and the power cord to be wound on respective similar spools with the mouse itself and the power supply being similarly fixable to the top of the laptop. In a typical application, it would no longer be necessary to stow the mouse, the cable, the power cord or the security lock in a separate laptop case. All the typical accessories would be simply attached by Velcro® to the openable display of the laptop.

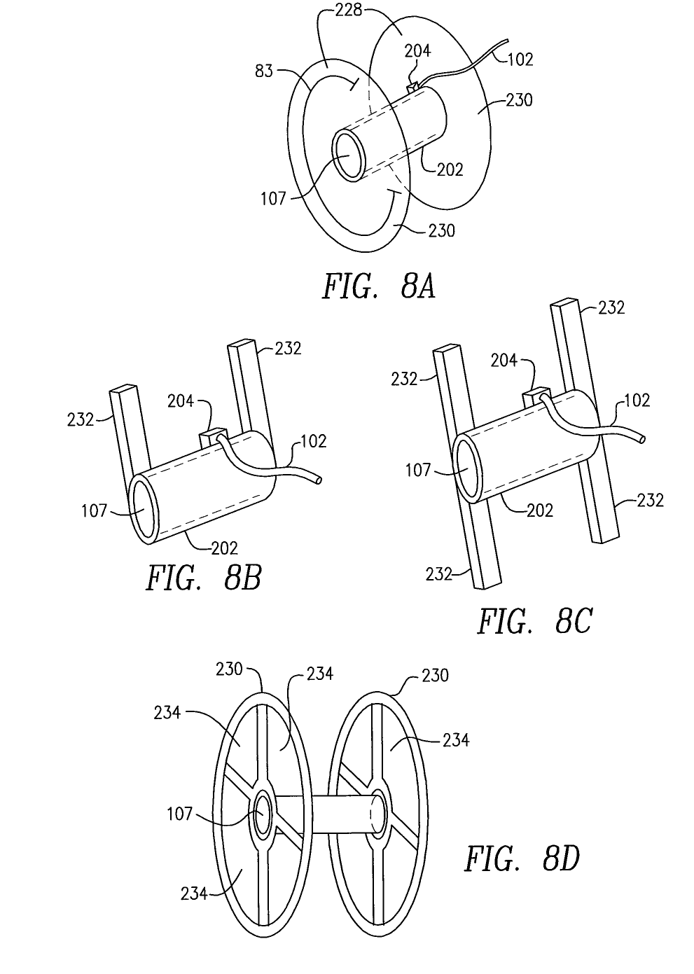

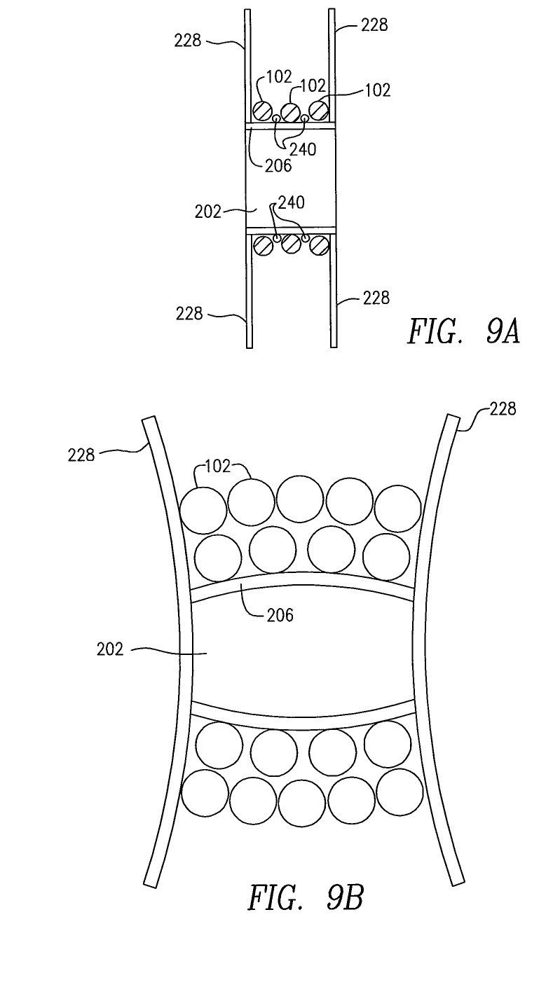

Referring now to FIG. 9A, according to another aspect of the present invention, spaced ridges 240 may be provided on exterior surface 206 of a hub 202. Ridges 240 are preferably spaced laterally by a distance that is about equal to the diameter of cable 102, whereby, when cable 102 is directly wound on exterior surface 206, the lateral spacing of the windings of cable 102 that directly reside on hub 202 is proper. As a result, the subsequent winding should also become properly spaced and aligned.

Referring to FIG. 9B, the exterior surface 206 of hub 202 may be convex according to another aspect of the present invention. Furthermore, retainers 228 may have convex surfaces facing one another. As a result, as cable 102 is wound around hub 202, the number of windings that are lateral to one another can be increased relative to the number of windings residing directly on exterior surface 206 of hub 202. For example, the number of lateral windings residing directly on surface 206 may be four, and the subsequent layer of lateral windings may be five and so on. Note that such an arrangement may reduce the number of layers of lateral windings and thus render the arrangement more compact.

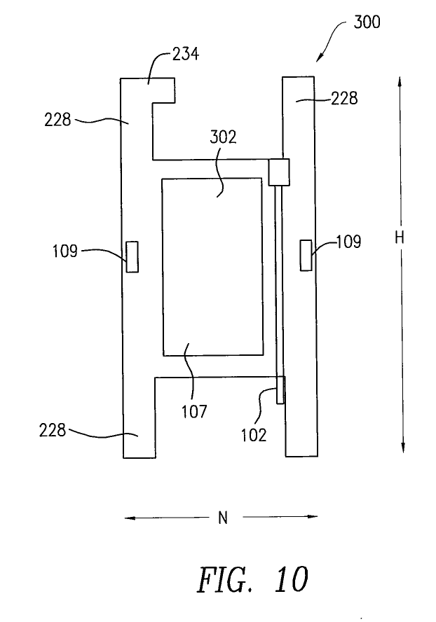

Referring to FIG. 10A, an arrangement according to the present invention is not restricted to circular or cylindrically shaped hubs. Rather, other shapes may be employed to realize the objectives of the present invention. Thus, as shown by FIG. 10A, a flat metallic web 300 may be provided with a center opening 107 to serve the same function of receiving lock assembly 115 therein. Flat metallic web 300 may be made from a thick (e.g. 1-3 mm thick) sheet of steel or aluminum (preferably plastic-coated), and may include an anchor 204 coupled to a surface thereof by welding or any suitable method. As in the previous embodiments, anchor 204 receives an end of cable 204 and is oriented to align cable 102 in the proper winding direction around web 300. Web 300 may be provided with retainers 228 which may be unitarily integrated arms that are spaced from one another and extend from opposite sides of web 300. Note that one (or more) of the retainers may be provided with a protrusion 234, serving the same function as the protrusion discussed above (see FIG. 7B). Note that retainers 228 and web 300 may be stamped out of a sheet of metal and thus constitute a unitary body. Further note that while opening 302 and H-shaped web 300 are generally rectangular in the embodiment shown by FIG. 10A, the rectangular shape is provided as an example only. Further, one (or several) securing slot(s) 109 may be provided on a retainer arm 228 for the same reasons set forth above. Slot 109 may be positioned on web 300 in an alternative arrangement.

A second cable 102 having a lock assembly 110 at one end thereof can be coupled to this embodiment or the other embodiments using another anchor. A second cable 102 would allow for securing of portable object having a security slot 117 on the one hand, and the securing of a portable object without a securing slot 117 on the other hand using the slot 109 (in one of the retainer 228 as shown or in the web 300) as earlier described.

It should be noted that while the examples herein show several windings of a cable 102 arranged lateral to one another, a hub 202 can be devised that includes only one winding or two windings per layer without deviating from the scope and spirit of the present invention. Thus, the width W and height H of the web 300 are fully selectable to obtain the device product dimensions.

By eliminating a retraction mechanism, a hub arrangement having a commercially acceptable size may be realized, which would allow the use of thicker and stronger and more secure cables (e.g. diameters larger than 4 mm).

Furthermore, the ability to wind a cable around a hub advantageously allows the user to tether the cable to a chair or the like object first (as explained above), and wind a portion of the cable around the hub (i.e. take up a portion of its slack) before locking the locking arrangement to the portable object.

Furthermore, using a flat, web for a hub (e.g. embodiment of FIGS. 10A, 10B) allows the user to select narrower regions for tethering cable 102.

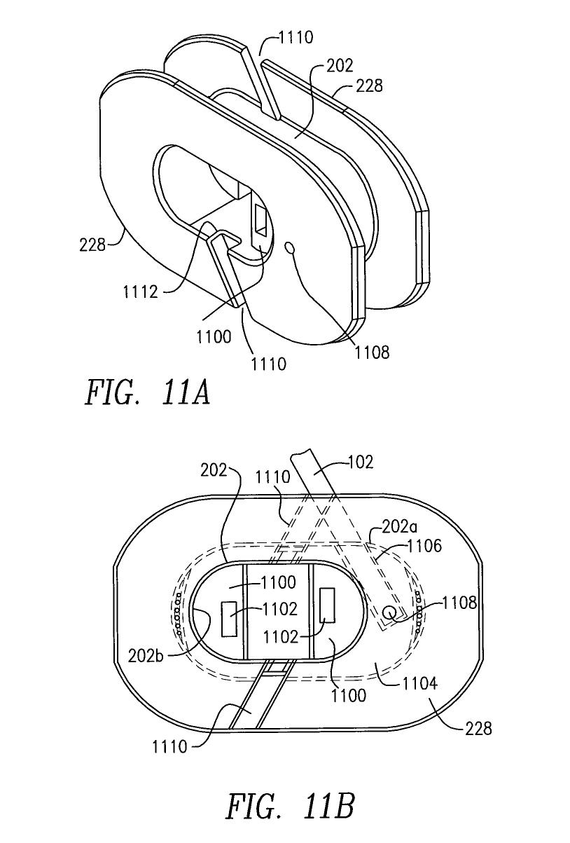

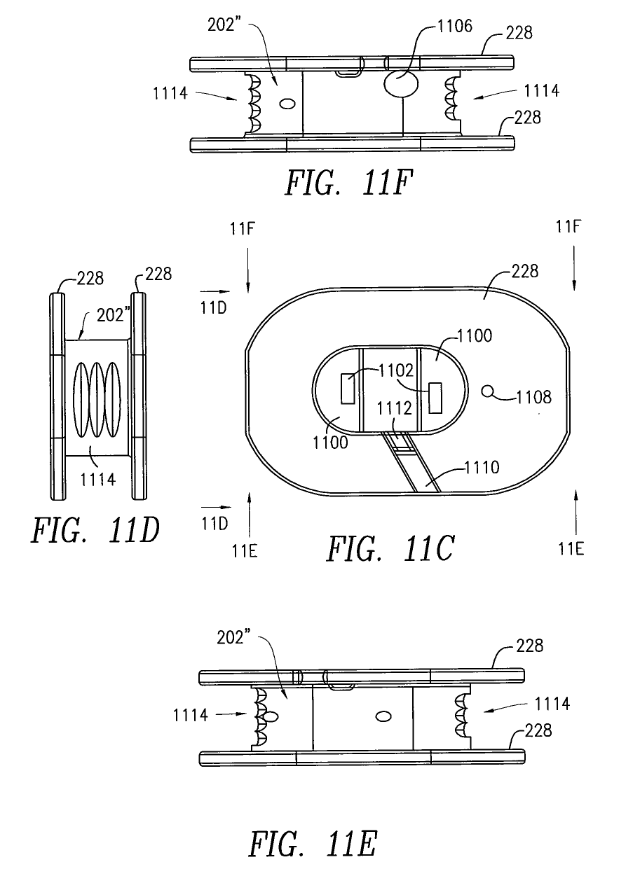

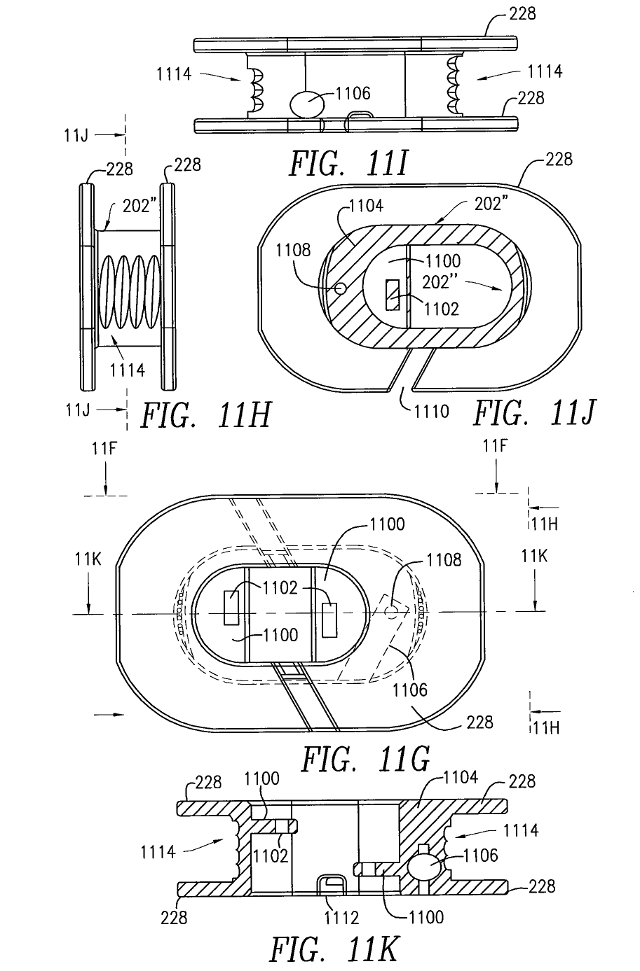

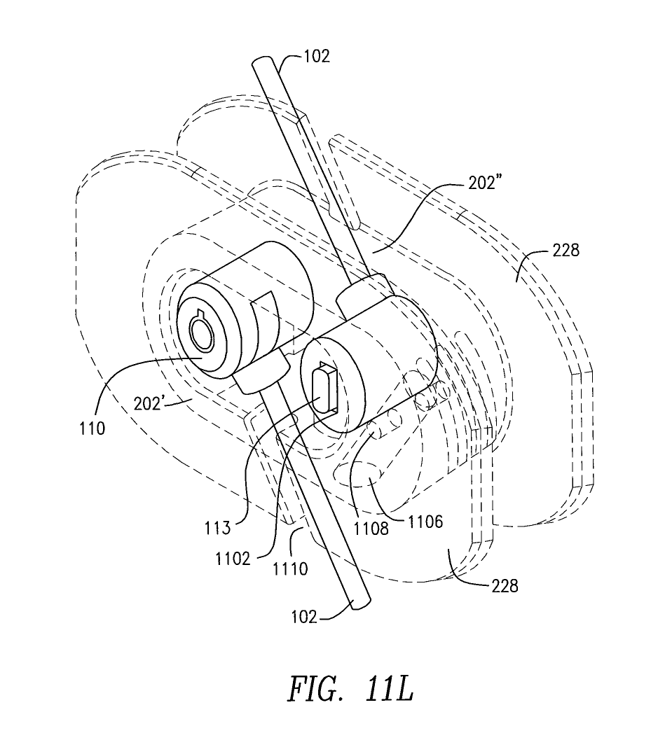

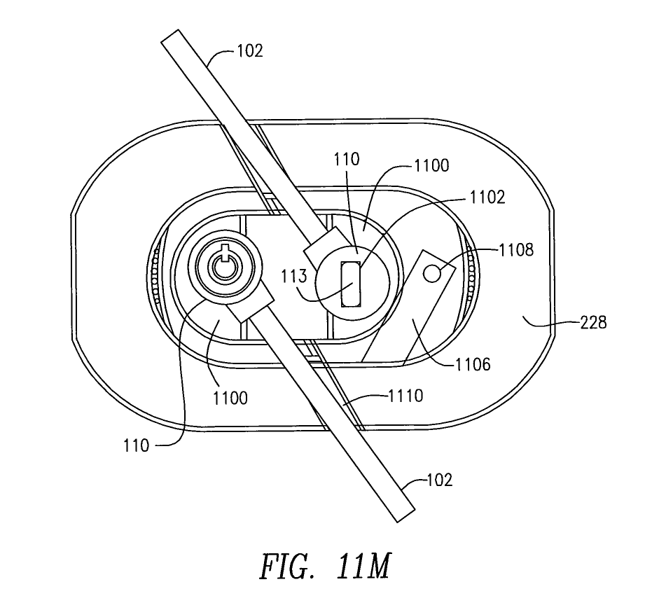

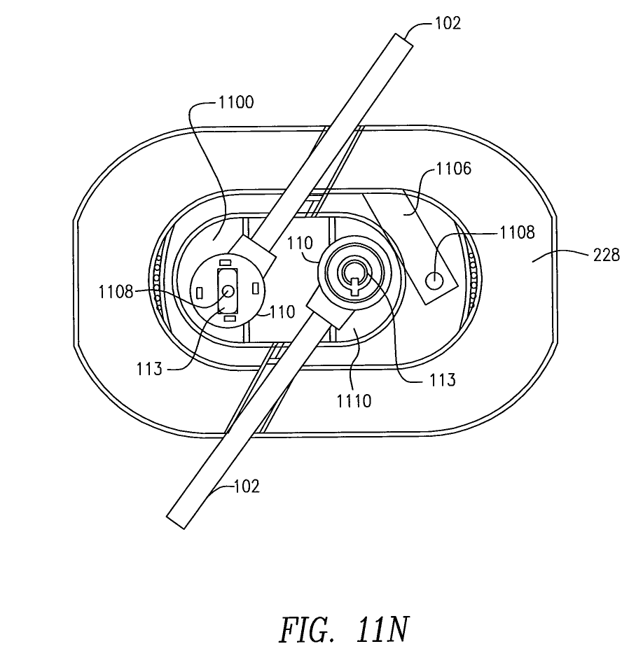

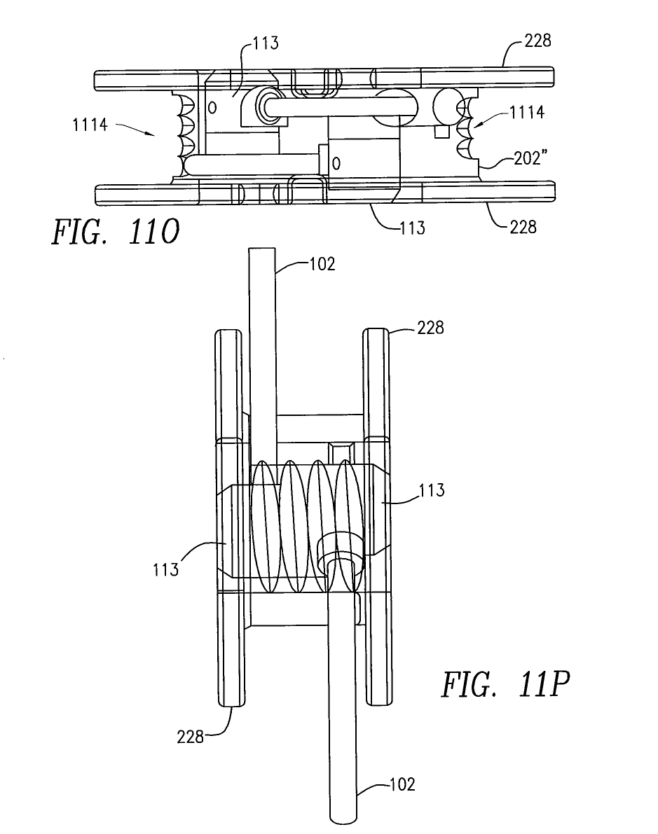

Referring to FIGS. 11A and 11B, an arrangement according to yet another embodiment of the present invention includes retainers 228 and a hub 202 similar to the embodiments described above (see, e.g. FIG. 7A). In this embodiment, hub 202 may be an oval cylindrical body with an exterior surface 202a. Thus, the exterior surface 202a of hub 202 can provide the same external surface to accommodate the winding of a cable 102, but with a narrower profile in one direction. The interior surface 202b of hub 202 may also be oval (or nearly oval with a medial rectangular section). According to one aspect of the present invention, at least one locking tab 1100 is disposed in the interior of hub 202. Locking tab 1100 is preferably a web-shaped body (i.e. a flat body) that is integrated with hub 202 and extends from interior surface 202b of 202 into the interior of hub 202. Locking tab 1100 includes a through-opening 1102 therein which is sized and shaped to receive a locking head such as a T-shaped latch 113 of a conventional lock assembly 110 as described above (see FIG. 1A). Note that hub 202 may be provided with two locking tabs 1100 as described without deviating from the scope and spirit of the present invention. Note further that the interior surface 202b of hub 202 and the exterior surface 202a of hub 202 are not coaxial. Consequently, the thickness of hub 202 varies as seen in FIG. 11B. Thus, as illustrated by FIG. 11B, hub 202 may be thicker at one side 1104 (see left side of hub) thereof. An anchoring blind hole 1106, which extends from the exterior surface 202a of hub 202 into its thicker 1104 side may be provided to receive an end of a cable 102. Once received in hole 1106, the end of cable 102 may be secured to hub 202 by any appropriate means. For example, a pin or the like may be inserted through hub 202 via a pin hole 1108 into the end of cable 102 in order to secure the same to hub 202. To align the lock assembly 110 (coupled to the other end of cable 102 as seen, for example, in FIG. 1A) and a latch/bar 113 thereof with a respective locking slot 1102 of a respective locking tab 1102, one or both of the retainers 228 may be provided with a cut-away 1110 which extends into and is aligned with a groove 1112 in the body of hub 202. Each cut-away 1110 and groove 1112 is wide enough to receive a portion of cable 102 therein.

Referring to FIGS. 11C-11E, in which like numerals identify like features, optionally, laterally positioned guiding grooves 1114 may be formed on the exterior surface 202a of hub 202 in order laterally position each winding of cable 102 along exterior surface 202a as it is wound around hub 202. In FIG. 11E, note the optional dimensions of the hub and its retainers, including the length of 97 mm, width of 61 mm, the slot size of about 4×9 mm, thickness of 28 mm and cut-way of 5 mm for holding a similarly sized cable diameter. The slot size may measure 3×7 mm when used with a lock having a T-bar made to fit that slot size.

FIGS. 11G-11K, in which like numerals identify like features, disclose cross-sectional views (see specifically FIGS. 11J and 11K) that more clearly illustrate the features described above. Furthermore, according to another aspect of the present invention, locking tabs 1100 are not directly opposite one another. Moreover, each tab 1100 is positioned a different distance from respective openings of hub 202. That is, neither tab 1100 is equidistant from respective opposite openings of hub 202. Note that in the preferred embodiment, each tab 1100 is spaced far enough from a respective opening of hub 202, in order to provide enough space for receiving a lock assembly 110, whereby, after cable 102 is wrapped around hub 202, a lock assembly 110 which is coupled to the other end of a cable 102 received in hole 1106, can be received in the interior of hub 202 as illustrated by FIGS. 11L-11P. Thus, lock assembly 110 can be locked to a respective tab 1100 (e.g. by inserting the latch thereof in slot 1102 of tab 1100) in order to retain cable 102 in the wound condition around hub 202. Actually, providing a single tab is preferred, to allow forming a larger lock threading path through the interior of the hub. Also, although not shown, additional slots may be formed in and through the walls of the retainers 228.

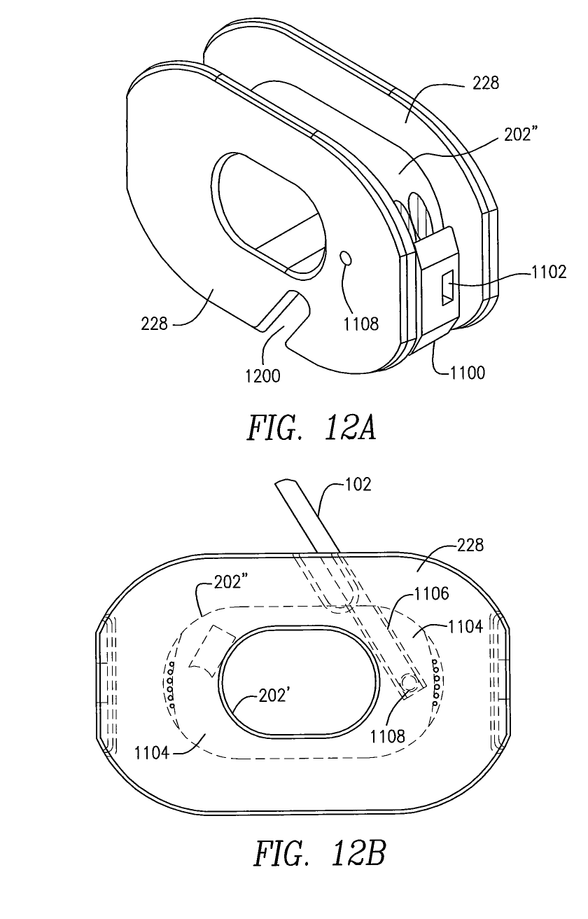

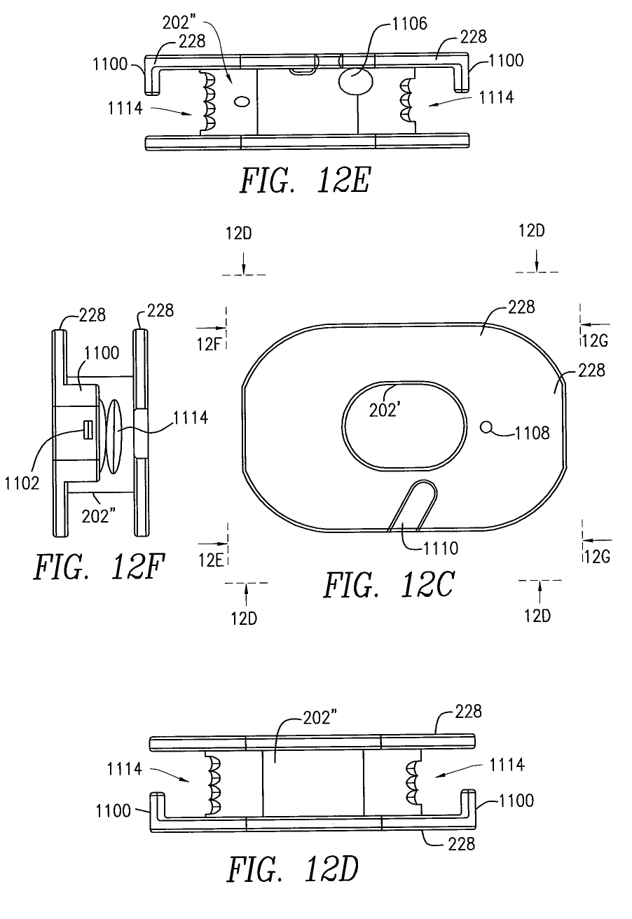

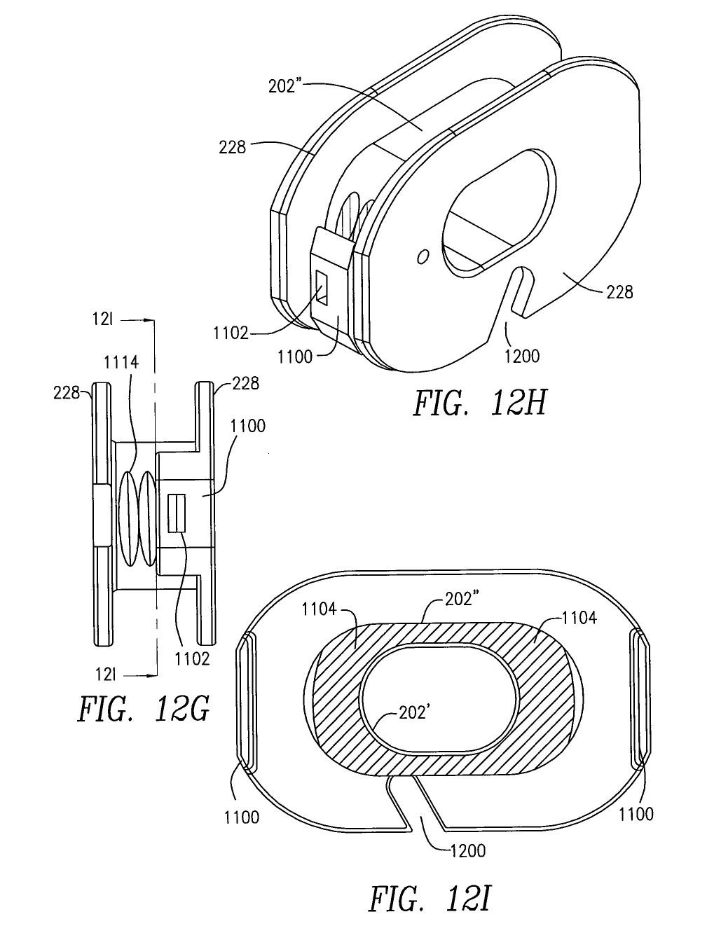

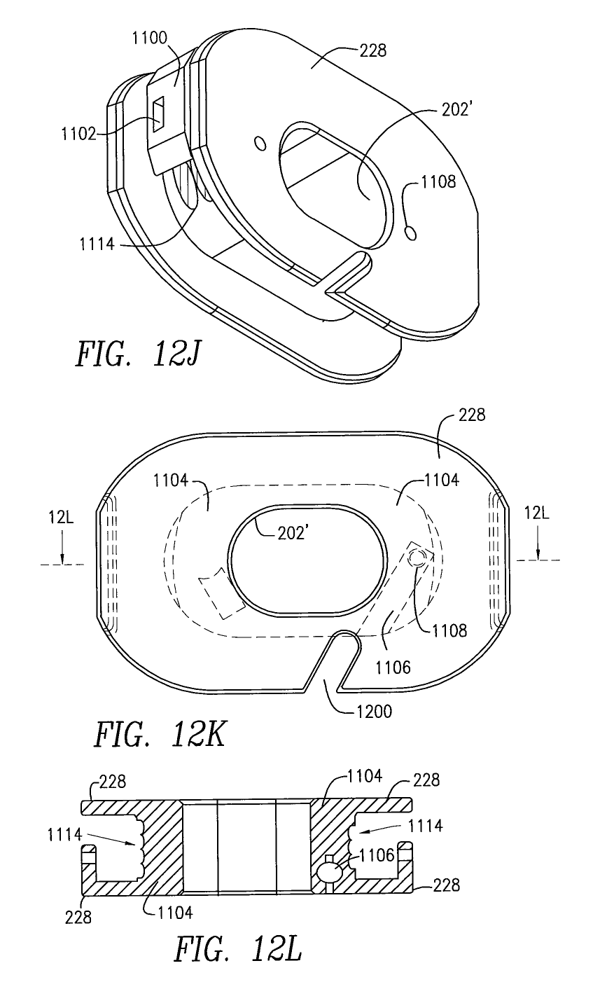

Referring now to FIGS. 12A, 12B, in which like numerals identify like features, an arrangement according to yet another embodiment of the present invention includes at least one locking tab 1100 having a locking slot 1102 positioned at the peripheral edge of a respective retainer 228 and extending substantially parallel to the exterior surface 202a of hub 202. Furthermore, one or both retainers 228 may be provided with notch 1200 in the body thereof which is sized to receive a cable 102 that is connected to hub 202 in the same manner described above. Note that in this embodiment, interior surface 202b and exterior surface 202a of hub 202 are coaxial, whereby hub 202 may include two opposite thickened sides 1104 as illustrated by FIG. 12B.

FIGS. 12C-12F, in which like numerals identify like features, further illustrate the feature of the embodiment shown by FIGS. 12A and 12B. As shown by FIGS. 12D, 12E, a retainer 228 may include two locking tabs 1100 each on an opposite side of the retainer.

FIGS. 12G-12L, in which like numerals identify like features, show further illustrations of the features described above. In general, in the foregoing embodiments, one end of the cable is affixed to the hub and is preferably oriented to be wound onto the hub. The other dangling end of the cable, to which the lock is attached, is then positioned in the cut-out 1100 and the lock is pushed into the interior of the hub, and its T-bar locking elements is used to lock the lock to the slot in the tab. Thus, the lock and the cable are neatly stowed on and in the hub. This presents a neater product package that can be shipped to users, or which users can store in their briefcases, desk drawers and the like. Preferably the length of the cable is optimized to be neatly wound on the hub without any portion of the cable presenting an unseemly dangling appearance.

In use, the lock is first unlocked from the anchoring tab, unwound off the hub to a desired cable length, and then the lock is threaded through an armrest of a chair or the like and then passed through the center opening of the hub. The cable is then secured to a security slot in a computer, display or the like, in the manner well known in the art.

Alternatively, the free lock can be passed through the shoulder strap or the hands of a lady's handbag, or briefcase or the like, and then locked to the slot in the hub, to thus secure against theft items that do not have the standard 3×7 mm security slot.

In general, in the embodiments of FIGS. 2A through 12L, one can discern a basic common structure comprising:
a. a small lock with a T-bar protruding from one end, the lock being key or combination operated and the like;
b. an anchor assembly;
c. a cable extending between and connecting the lock to the anchor assembly; and
d. an opening passing through the anchor assembly, large enough to thread the lock through that opening to thereby enable the anchor assembly to be passed through a comparatively immovable or very heavy object and thus secure the anchor assembly to the immovable object, with the lock end being available so that its T-bar can be inserted into standardized, typically rectangular security slots provided as a standard feature in equipment such as in laptop or notebook computers and similar electronic devices.

Typically, the anchor structure is provided with one or more rectangular slots, whereby the T-bar of the lock can be looped back to the anchor structure and locked therein. This enables locking objects which do not have the built-in security slot, for example, a briefcase, clothing, etc.

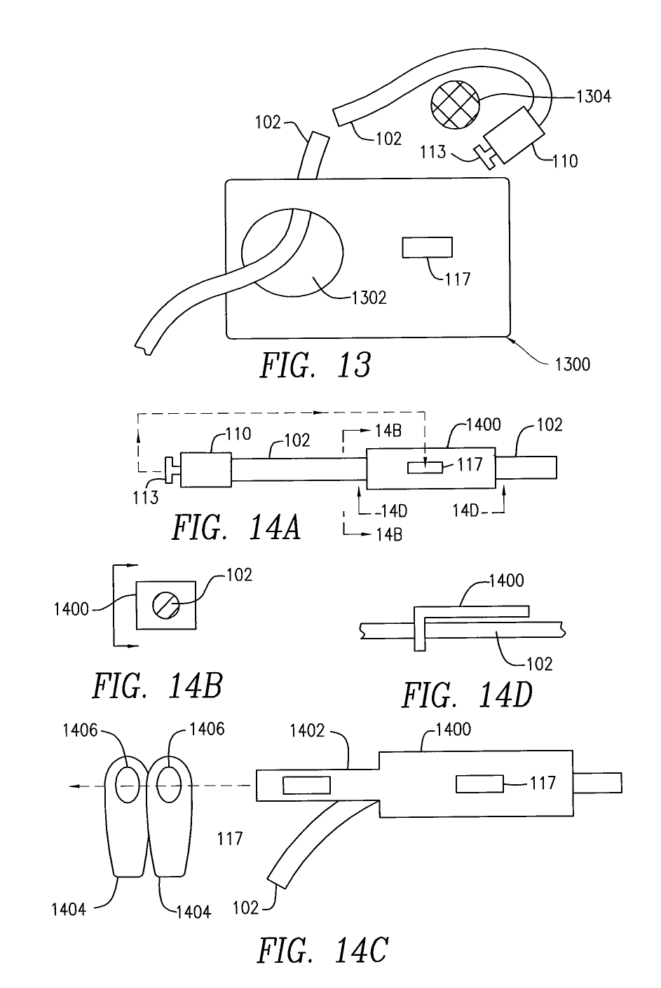

Referring to FIG. 13, according to another aspect of the present invention, a conventional lock/cable assembly (see FIGS. 1A, 1B) can be provided with an accessory 1300. Accessory 1300 may be a metallic web having a slot 117 for receiving the T-shaped latch 113 of a lock assembly (see FIG. 1A) and another through opening 1302 large enough to allow passage of lock assembly 110 therethrough. Accessory 1300 can be thus used to form a loop around an object 1304 by passing the lock assembly 1100 through opening 1302, around object 1304, and then lock assembly 1100 to slot 117. As can be appreciated, accessory 1300 allows the size of the loop to be adjusted to accommodate loops around a variety of objects.

Referring next to FIGS. 14A, 14B and 14D according to another aspect of the present invention, a locking tab 1400 that includes a slot 117 therein can be irremovably secured to the indicated position on cable 102 as illustrated, for example, about one foot away from the lock. Thus, cable 102 can loop around any object and then lock assembly can be locked to locking tab 1400 by passing T-shaped latch 113 thereof through slot 117 in tab 1400. Here, the body of the locking tab is aligned lengthwise with the cable 102, for easier stowage, or winding on the hub.

Referring to FIG. 14C, tab 1400 may include an extension 1302 that extends from one side thereof. Extension 1402 is provided with a slot 117 for receiving a latch 113 of a conventional lock assembly (see FIG. 1A). Extension 1402 may be sized narrow enough, e.g., 4-5 mm in width (enough to form a 3×7 mm slot), to enter the openings 1406 at the end of zipper heads 1404, e.g., of a lady's handbag (not shown). Thus, extension 1402 may be inserted into openings 1406 of two zipper heads, and then a lock assembly 110 can be locked to slot 117 of extension 1402 in a conventional manner, whereby the zipper heads can be locked in place. This embodiment allows locking the zipper of the handbag to secure the contents inside.

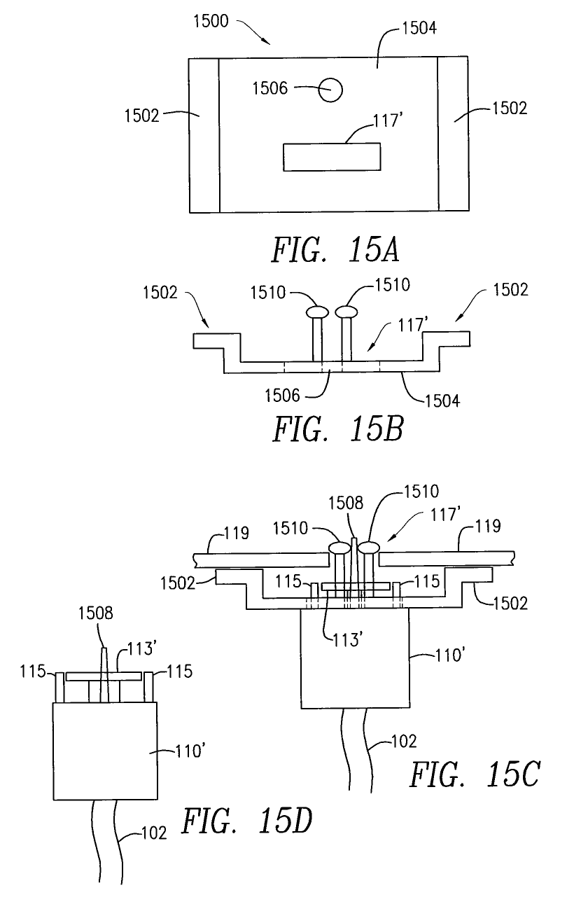

FIGS. 15A and 15B illustrate an adapter plate 1500 which can be used to enlarge the size of a lock assembly having a larger and more robust latch. Plate 1500 is preferably a metallic body having two feet portions 1502 of opposite edges of a center web portion 1504. Center web portion 1504 includes a slot 117′ which is larger than a conventional slot 117 for receiving a larger latch. Web portion 1504 further includes a pin hole 1506. Adapter plate 1504 is also provided with two catch portions 1510. Each catch portion 1510 is disposed at one side of pin hole 1506, includes an enlarged head at its free end, and is capable of cantilever motion.

Referring to FIGS. 15C and 15D, in which like numerals identify like features, a lock assembly 110′ that includes a T-shaped latch 113′ that is larger than a conventional latch 113 capable of reception in a conventional 117 slot, as described above, can be provided with an expansion pin 1508.

In use, feet portions 1502 of adapter plate 1500 abut a body 119 that includes a conventional slot 117. Catch portions 11, which extend further than feet portions 1502, flex and enter slot 117 and the heads thereof pass therethrough as illustrated. When T-shaped latch 113′ of lock assembly 110′ enters slot 117′, expansion pin 1508 is received in hole 1506 between catches 1510. As illustrated, expansion pin 1508 may be sized and shaped to press against the heads of catches 1510 in order to push the catches against the sidewalls of slot 117 to firmly secure adapter plate 1500 to body 119.

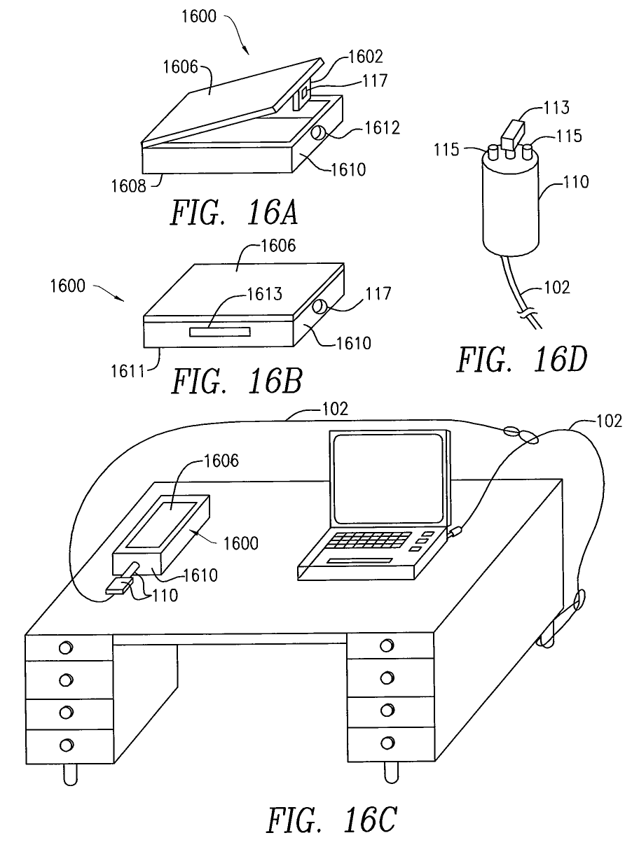

Referring to FIGS. 16A-16D, in which like numerals identify like features, in yet another embodiment, a box 1600 can be provided with features so that it may be locked by a conventional lock and cable assembly (see FIG. 16D). Specifically, box 1600 includes a locking tab 1602 which can be web-shaped (i.e. a flat) body having a slot 117 formed therein. Locking tab 1602 is connected to a top 1606 which is preferably hingedly coupled to a wall of a five-sided receptacle 1608. Another wall 1610 of box 1600 may include a through hole 1612 which is positioned to register with slot 117 on tab 1602. Thus, once top 1606 closes the opening in receptacle 1608, slot 117 registers behind hole 1612 inside receptacle assembly 110 to tab 1602 through hole 1612 in the conventional manner.

Referring to FIG. 16C, a lock and cable assembly can now be used to secure box 1600 to another object in the conventional manner. For example, as shown by FIG. 16D, box 1600 can be locked and secured to another cable 102 (which is itself secured to the leg of a table) using a conventional lock and cable assembly. The advantage in FIG. 16C is that the same key is used to operate the locks that attach to the laptop computer as to the box 1600. Sensitive papers, or computer media may be locked within the box during lunch breaks, etc. Computer media may be pushed into the box through the slot 1613 (FIG. 16B) while the box is locked. Of course, other valuables such as money, telephones and the like may be safeguarded therein. The cable to the box may be quite short—2-3 feet considering its use as part of a kit. The box may be 9 by 12 inches. Or the box may be sized to also serve as a carrying case for a laptop computer, with additional compartments to share accessories, e.g., power cables, etc., therein, and with a carrying handle.

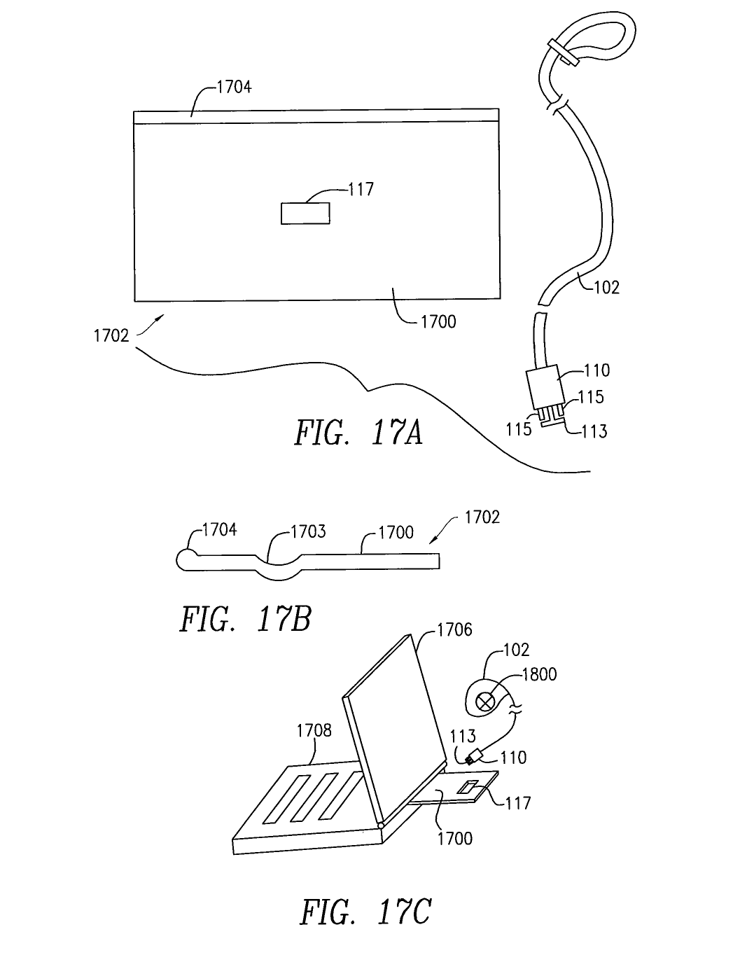

Referring now to FIGS. 17A-17C, in which like numerals identify like features, a kit is provided which includes a conventional lock and cable assembly useable with a locking plate 1702. Locking plate 1702 includes a web 1700, which is preferably a metallic body and a head portion 1704. Head portion 1704 preferably forms a unitary integrated body with web portion 1700 and is located along one edge of web portion 1700. Note that head portion 1700 is thicker than web portion 1700.

It is known that a conventional laptop computer includes a monitor 1706 hingedly coupled to a keyboard/computer portion 1708, whereby it can be opened and closed like a folder. Once in the open position, a gap exists between the monitor 1706 and keyboard 1708. In one embodiment, plate portion 1700 is made thin enough to be received inside the gap between monitor 1706 and keyboard 1708, while head portion 1704 is thicker so that it may not pass through the gap. Thus, as illustrated by FIG. 17C, when plate portion is passed through the gap between monitor 1706 and keyboard 1708, lock assembly 110 can be locked to plate 1700 by passing latch 113 through slot 117 in the conventional manner, whereby the laptop can be secured to another object 1800 by wrapping cable therearound (see FIG. 1B for an example of a way of securing a laptop to an object such as a chair).

Consequently, no slot need to provided on the casing of a laptop. If needed, the head portion may have an arcuate section 1703 to accommodate the cylindrical hinge or axis of the monitor. See FIG. 17B.

One prevalently used industry standard for a slot 117 (see FIG. 1B) calls for a rectangular slot that is 3 mm×7 mm. Such a slot would naturally call for a latch 113 and holding pins 115 which when placed side by side can fit in the 3×7 mm slot. Consequently, a lock assembly 110 that can be locked to a standard 3 mm×7 mm is relatively small, and, therefore less robust and strong. Specifically, the stem portion of the T-shaped latch (about which the T head rotates) is relatively narrow (having a diameter less than about 2 mm) and, therefore, more susceptible to tampering and breaking.

According to one aspect of the present invention, an adapter is used to allow for the use of a more robust lock assembly. Generally speaking, an adapter according to the present invention allows for the use of larger, and thus stronger latches—and latches shaped other than T-bars—whereby the lock assembly is rendered less susceptible to compromise due to tampering.

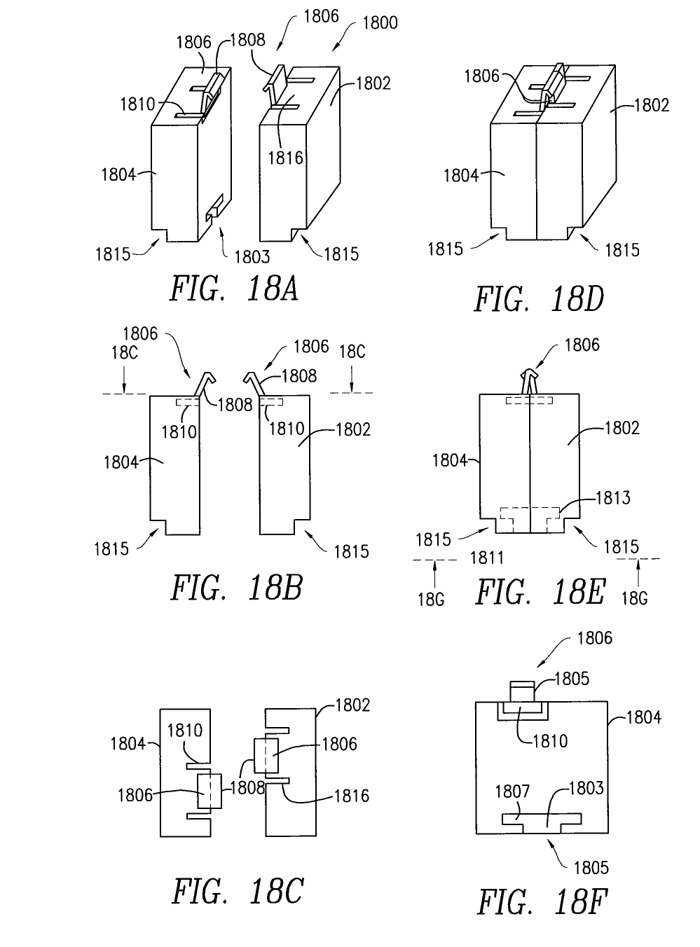

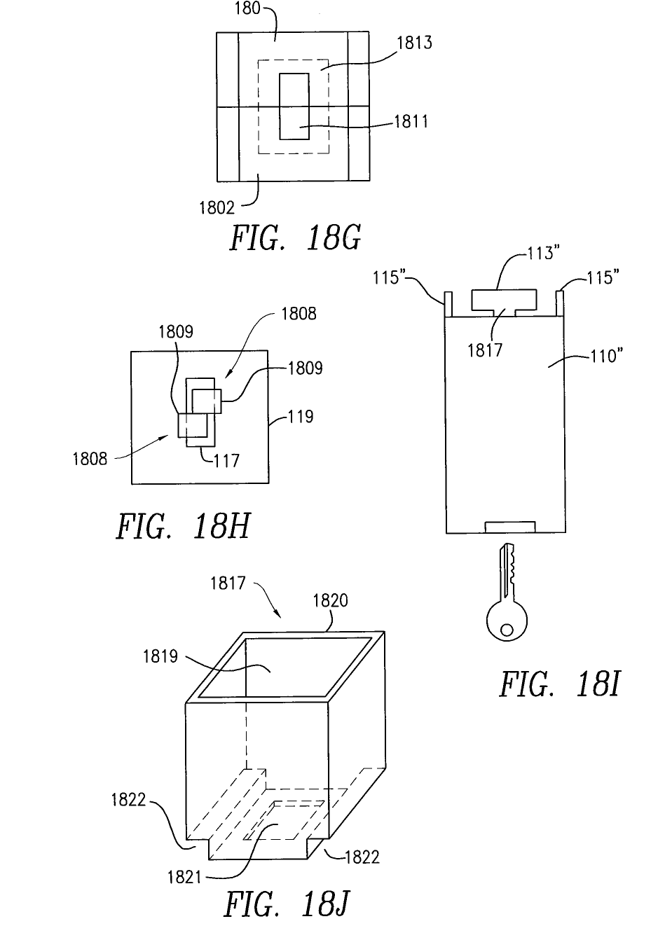

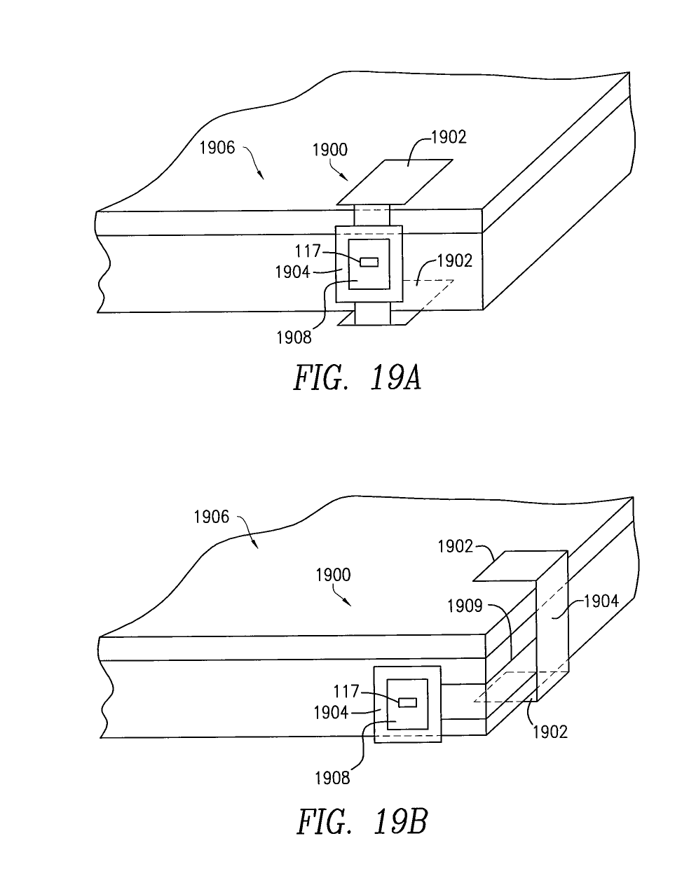

Referring to FIGS. 18A-18H, an adapter 1800 according to an embodiment of the present invention includes a first block 1802 and a second block 1804. Each block 1802, 1804 is preferably a solid metallic body having at one end thereof a catch arrangement 1806. Each catch arrangement 1806 includes a catch portion 1808 having a hook shaped free end and an opposite end which is coupled to a respective block 1802, 1804 for cantilever type motion. In order to facilitate and increase the range of motion of each catch portion 1808, each catch portion 1808 may be optionally coupled to a respective block via a cantilevered leaf spring 1810. Each such cantilevered leaf spring 1810 may be formed by cutting around a portion of the top end of a respective block 1802, 1804. To make use of adapter 1800, first block 1802 and second block 1804 are coupled to one another such that catch portions 1808 thereof are arranged side-by-side as illustrated for example by FIGS. 18D, 19E. Blocks 1802 and 1804 may be permanently coupled to one another by glue or the like. According to one aspect of the present invention, catch portions 1808 are shaped and sized so that they may be received inside a 3 mm by 7 mm slot 117 when blocks 1802, 1804 are coupled to one another. Thus, as illustrated by FIG. 18H, when catch portions 1808 are inserted inside a conventional slot 117, the hook-shaped free ends 1809 thereof abut the back of body 119 in which slot 117 is formed. Note that because catch portions 1808 are cantilevered, they flex so that the hook-shaped free ends 1809 thereof fit inside slot 117. However, after hook-shaped free ends 1809 pass through slot 117, catch portions 1808 return toward their natural positions, whereby hook-shaped free ends 1809 abut body 119 and adapter 1800 cannot be withdrawn, and the blocks naturally burrow deeper into the slot providing a tight and wiggle-free hold.

Note that according to as aspect of the present invention, while adapter 1800 is intended to be permanently anchored to body 119, if necessary, blocks 1802 and 1804 may be separated from another with, for example, a screw driver. That is, the glue joint between blocks 1802 and 1804 provides an intentionally weaker area that can be broken in order to withdraw adapter 1800. Note that such an action would destroy the adapter 1800. Thus, adapter 1800 cannot be considered a reinstallable item once installed.

Referring now to FIGS. 18A, 18F, and 18G, each block 1802, 1804 includes a cutaway 1803 on a side thereof. Thus, for example, each block 1802 includes a cutaway 1803 on a side opposite to catch arrangements 1806. Each cutaway 1803 includes a narrow region 1805 which extends into a wider region 1807. Thus, when blocks 1802 and 1804 are coupled to one another adapter 1800 will include a narrow channel 1811 leading into a wider chamber 1813. Note that narrow channel 1811 allows for the entry of a T-shaped latch or the like body, while the wider chamber 1813 provides a wall against which the head of the T-shaped latch may be abutted to prevent the lock from being withdrawn. Note that according to the present invention, narrow channel 1811 is wider than a conventional 3 mm×7 mm slot, whereby a larger more robust latch may be used with adapter 1800, for example, one that is sized to enter a slot of 5×9 mm.

Each block 1802, 1804 in an adapter 1800 may further include a recess 1815 along an edge thereof. Recesses 1815 are disposed opposite one another and channel 1811 is disposed between the recesses when blocks 1802, 1804 are coupled to another. Referring to FIG. 18I, according to another aspect of the present invention, a lock assembly 110″ includes a T-shaped latch 113″ which includes a stem 1817 (the portion of the T-shaped latch that is rotatable about a central axis thereof) that is much thicker than the stem of a conventional latch 113. For example, step 1817 may have a diameter that is 5 mm or more thick. Lock assembly 110″ may further include two walls 115″ positioned on respective sides of T-shaped latch 113″ opposite one another. In use, walls 115″ are received in recesses 1815 when T-shaped latch 113″ is inserted through channel 1811, whereby axial rotation of lock assembly 110″ is prevented. Note that instead of walls 115″ pins may be used without deviating from the scope and spirit of the present invention. Furthermore, instead of recesses 1815 along opposite edges of adapter 1800, and open or blind holes may be provided on the adapter 1800 around channel 1811 for receiving the pins in order to prevent lock assembly 110″ from rotating. Note that it may not be necessary to use two pins. One pin or more than two pins may be used to prevent lock assembly 110″ from rotating without deviating from the scope and spirit of the present invention.

Referring to FIG. 18J, a sleeve 1817 may be used to further strengthen adapter 1800. Sleeve 1817 is a body that includes an interior space 1819 defined by interior surfaces arranged to nearly correspond to the exterior surfaces of adapter 1800. Thus, as can be seen in FIG. 18J, the interior surfaces of sleeve 1817 defines a generally cubical space for receiving a generally cubical adapter 1800 as seen in FIG. 18D. Sleeve 1817 includes an opening 1820 at one end that is large enough for the entry of an adapter 1800 into space 1819 and another opening 1821 that registers with channel 1811 so that a latch 113″ may be received inside adapter 1800 once it is inside sleeve 1817. Note that sleeve 1817 may include recesses 1822 opposite one another which perform the same function as recesses 1815 of adapter 1800. Opening 1821 is disposed between recesses 1822. Preferably, lock assembly 110″ is large enough so that, once latch 113″ is received in adapter 1800, opening 1821 is completely covered and rendered inaccessible, whereby the arrangement is rendered less susceptible to tampering.

Referring to FIG. 19A, a clamp can be used in combination with a lock and cable assembly in order to provide further security to a portable object such as a laptop. Specifically, a clamp 1900 according to the present invention may include two clamping plates 1902 and the body 1904 which extends from one edge of a clamping plate 1902 to an edge of another clamping plate 1902. Tie body 1904 can clamping plates 1902 are integrated with another and preferably form a unitary body. Note that while the body 1904 extends between the two clamping bodies 1902, each clamping body 1902 includes a free end. Thus, when a laptop 1906 or the like is in a closed state, clamp 1900 can be slid over laptop 1906. According to an aspect of the present invention tie body 1904 includes an opening 1908 therein. In use, opening 1908 is registered with a slot 117 in the casing of laptop 1906. Thus, when a lock assembly 110 is locked to slot 117 in the conventional manner clamp 1900 is rendered immovable, whereby clamp 1900 with prevent the laptop 1906 from being opened. It should be noted that opening 1908 is smaller than the lock assembly 110 in order to prevent clamp 1900 from being removed once the lock assembly 110 is locked to laptop 1906. Note further that a clamp 1900 according to the present invention can be used with an adapter or without an adapter.

Referring now to FIG. 19B, in which like numerals identify like features, opening 1908 is not formed in the body 1904. Rather, an extension plate 1909 which is integrated with the body 1904 extends from an edge thereof to a lock plate 1920 in which opening 1908 is formed. Note that in the embodiment shown extension 1909 goes around the corner of laptop 1906. Further note that, in use, extension 1909 can be arranged to cover a CDROM/DVD receptacle to restart access to the same to secure the content therein.

Note that the opening 1908 may be sized and shaped to fit and hold onto the adapter 1800.

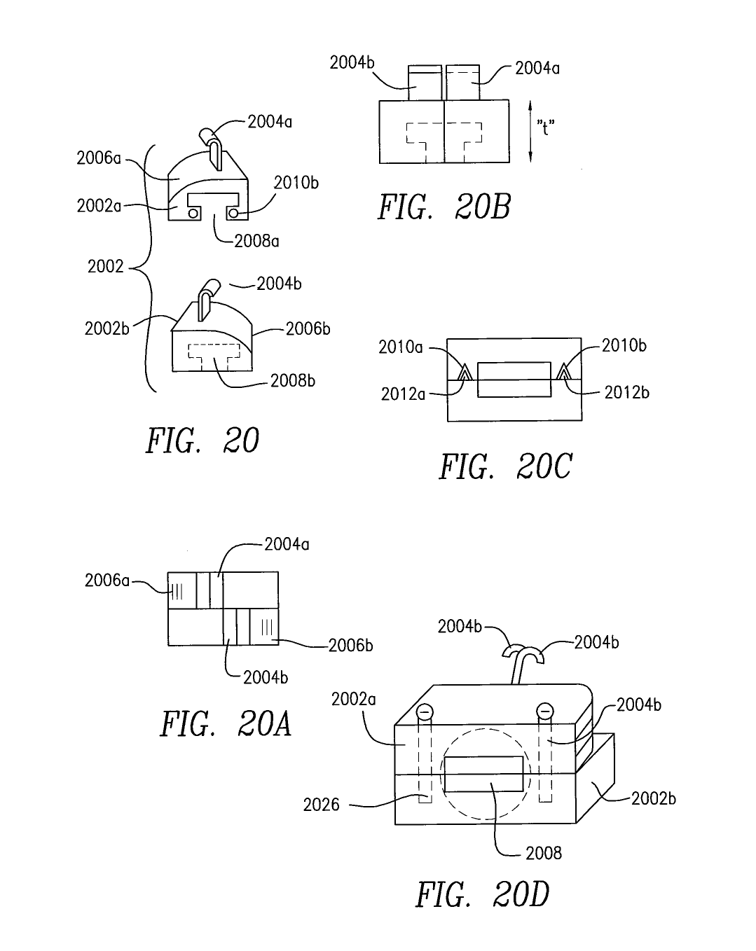

With reference to FIGS. 20, 20A, 20B, 20C and 20D, the differently configured adapter 2002 of this embodiment is comprised of two joinable blocks 2002a and 2002b, each having its respective slot grasping, L-shaped pin 2004a, 2004b. The cross sectional size of the stem of each pin is about 3×3.5 mm, so that when the two blocks are joined, the adjacently placed pins fill and tightly grasp the conventional security slot, measuring 3 by 7 millimeters. See FIGS. 20A and 20B. The horizontally extending portion of each L-shaped pin is capable of being inserted into the slot by bending each block so that it touches the wall of the device being secured at its respective tapered portion 2006a, 2006b. See FIGS. 20A and 20B.

In effect, the pins are rotated into slot, the shape of the pins being such that they tend to burrow deep and tightly grasp the security slot. When the bodies of the blocks become aligned after their pins have been inserted into the slot, they snap together owing to the beads 2012a,b snapping into the detents 2010a,b, as best seen in FIG. 20C. To ensure that the two blocks will remain registered with each other, their facing surfaces are covered with an adhesive (normally covered during shipping) which when exposed causes the blocks to become permanently joined. Alternatively (or additionally), the two blocks may be covered by the aforementioned sleeve which is of course shaped to the dimensions and shapes of the blocks 2002a and 2002b. Further, pins or screws 2026 may be inserted to hold blocks. To remove the adapter (assuming some need arises to do so), the adhesive or pins may be broken by a screwdriver being wedged between the blocks.

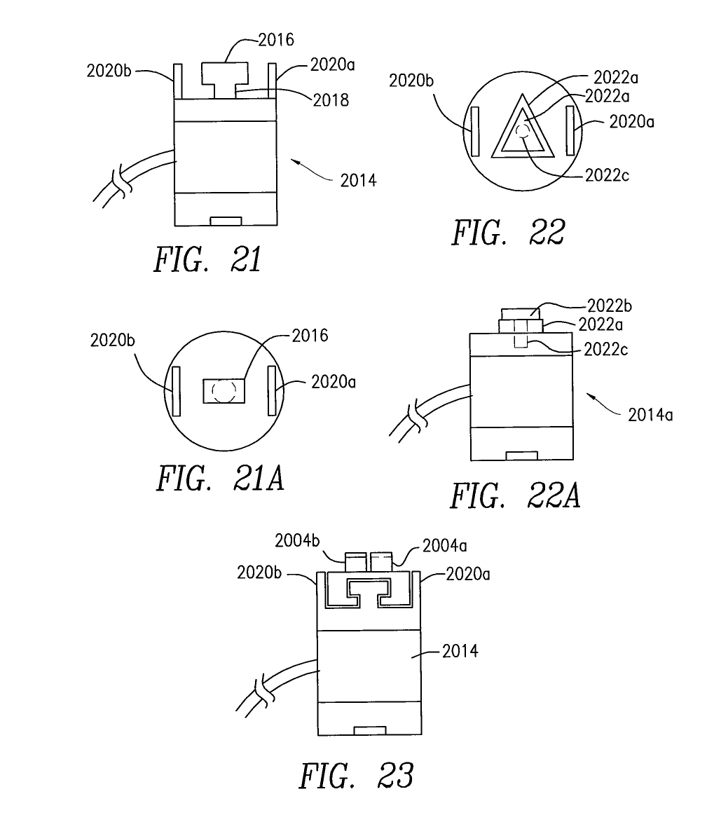

Carved into each of these blocks is one half of a blind hole/slot 2008a and 2008b, which together define a slot of say 5×9 mm, which allows insertion of a much sturdier T-bar locking member. Also, rather than having to insert anti-rotation pins into the security slot proper, the lock 2014 (FIG. 21) having the T-bar 2016 with a stem 2018 of 5 mm diameter and a wing span of 9 mm, may be provided with anti-rotation, juxtaposed walls 2020a and 2020b which are positioned to the sides of the T-bar locking member and spaced at a distance such that they tightly hold the side walls of the adapter 2002 as shown in FIG. 23. Instead of as shown, these walls may be provided above and below the locking member, to aid in holding the blocks together and to prevent tampering.

In an alternative embodiment, the lock 2014a is designed to have a triangular platform 2022a shaped to penetrate a triangular opening formed in the adapter 2002, and to also include a rotatable triangular block 2022b on the platform. When the locking member 2022b is turned 90 degrees it defines a star-of-David shape and becomes locked in the adapter 2002. The embodiments thus described provide a permanent replacement for the standard 3×7 mm slot the adapter being designed to be removed only by breaking the connection between the blocks 2002a and 2002b.

As described above, it is desired that the adapter 2002 have a very small footprint and that it be permanently installed in the standard 3×7 mm slot to provide either a larger slot, or a differently shaped slot that is capable of accommodating a sturdier locking member. Further, the adapter 2002 is suited for supporting various brackets which can be utilized to close shut a laptop computer so that, for example during lunch hour, nobody can come over to the computer and operate it to gain access to confidential information. As noted several times, it is important that the adapter have a very small footprint when inserted into a laptop or other type of small equipment. Preferably, therefore, the length and width of the adapter along the sides shown in FIG. 20C should be on the order of about 15×20 mm. Its thickness, marked with the letter “t” in FIG. 20B, should be on the order of 8 to 10 mm. With this dimension, the adapter has a footprint and profile not much different than that of the lock 2014. Also, it is within the realm of the present disclosure that the pins 2004a, 2004b might be provided with a leading sharp tapering edge at the leading end thereof, and made of very resilient material, whereby the block 2000a and 2000b might be preassembled and the assembled block 2002 be simply pushed hard against the standard 3×7 mm security slot, until the adapter snaps into place and holds tightly to the security slot. The adapter may be made of very hard plastic, instead of a metal.

With the lock embodiment of FIGS. 21 and 22, it is not necessary to have pins that need to be inserted into the security slot on the adapter. The sidewalls 2020 are more suited to quickly align the lock with the slot. Indeed, although two sidewalls 2020 are shown, four of them may be provided and these walls may be made to totally surround the adapter, to prevent tampering with the adapter.

Although the present invention has been described in relation to particular embodiments thereof, many other variations and modifications and other uses will become apparent to those skilled in the art. It is preferred, therefore, that the present invention be limited not by the specific disclosure herein.

What is claimed is:

1. A locking assembly, comprising:
a lock having a protruding locking member which is configured to be inserted into a security slot formed in an object to be locked and for being turned within the slot to be locked therein;
an anchor structure having a through going opening which is sufficiently large to accommodate and allow the lock to pass therethrough;
a cable extending between and secured at one end to the lock and at another end thereof to said anchor structure; and
the anchor structure being formed of a rigid material and not being formed of said cable being looped unto itself, the anchor structure being sufficiently rigid to allow the formation therein of a security slot configured to receive and allow the protruding locking member to be locked to the anchor structure.

2. The locking assembly of claim 1, wherein the anchor structure is formed as a cable reel and configured to enable the winding thereon of a said cable.

3. The locking assembly of claim 1, wherein the anchor structure is formed as a flat object with the opening formed generally centrally in the flat object and the flat object being thin enough to allow the locking member to pass through a thickness of the flat object.

4. The locking assembly of claim 3, including at least one security slot formed in the flat object and sized to receive and pass the locking member of the lock assembly therethrough.

5. The locking assembly of claim 3, wherein the flat object comprises at least one L-shaped protrusion on which the cable can be wound.

6. The locking assembly of claim 5, wherein the anchor structure is formed from a flat metal sheet stock which is stamped to form a plurality of protrusions which are bendable to create the anchor assembly.

7. The locking assembly of claim 1, wherein the anchor assembly comprises a central hub having opposite end walls, to produce an H-shaped cross-section and defining a bound space in which the cable can be wound on the hub between the end walls.

8. The locking assembly of claim 1, wherein the anchor assembly is formed as a reeling spool having a central surface on which the cable can be wound and end walls which prevent the cable from falling off the reeling surface, with the throughgoing opening defining an interior space and the interior space comprising therein a member formed with a security slot, the anchor structure being such that the cable is capable of being wound on the reeling surface and the lock is designed for being stowed in the throughgoing opening with its locking member secured in the security slot.

9. The anchor assembly of claim 1, including a security slot defined and formed in the anchor structure.

10. The anchor assembly of claim 1, including a locking tab tethered to the cable and including a security slot therein, enabling the protruding locking member to be locked to the locking tab.

11. The anchor assembly of claim 10, in a kit including a holding box having an interior defined by a bottom wall, at least one side wall and a cover, and the cover being lockable to the side wall with the protruding locking member of the lock.
